(19) United States
(12) Patent Application Publication
(10) Pub. No.: US 2016/0239807 A1
(43) Pub. Date: Aug. 18, 2016

(54) METHOD AND SYSTEM FOR MANAGING AN EMPLOYER SPONSORED INCENTIVE PROGRAM

(71) Applicants: James Creighton, Yonkers, NY (US); David Taylor, Matteson, IL (US)

(72) Inventors: James Creighton, Yonkers, NY (US); David Taylor, Matteson, IL (US)

(21) Appl. No.: 15/019,958

(22) Filed: Feb. 9, 2016

Related U.S. Application Data
(60) Provisional application No. 62/113,908, filed on Feb. 9, 2015.

(51) Int. Cl. G06Q 10/10; G06Q 40/00

(52) U.S. Cl. CPC G06Q 10/1057; G06Q 40/123

(57) ABSTRACT

An approach is provided for facilitating and monitoring transactions associated with the purchase of employer sponsored benefits and/or incentives. An incentive platform processes and/or facilitates a processing of profile information associated with a user of a device to determine a status of the user as an employee of an employer. The incentive platform also determines an enrollment status of the employer for enabling the purchase of a benefit, an item, or a combination thereof from a service provider as an employer sponsored benefit, a participation level of the user, or a combination thereof based on the status of the user. Furthermore, the incentive platform initiates a request to purchase the benefit, the item, or a combination thereof on behalf of the user based on an incentive policy established by the employer, the enrollment status, the participation level, or a combination thereof.

### BACKGROUND INFORMATION

Employers are continually challenged to provide benefits and incentives to their employees as a means of enhancing employee morale and increasing retention. One area of interest has been providing employees with programs to reward their involvement with the employer (e.g., a company). For example, many companies offer benefits such as healthcare plans, retirement savings programs and commuter expense incentives. Typically, the cost of these benefits, or at least a portion thereof, is funded via a payroll deduction program (PDP). PDPs enable an amount of the employee's compensation to be automatically deducted from their paycheck on a regular basis for the purpose of funding benefits offered by a third party provider. Depending on how the benefit is classified by federal or state authorities, the deduction may be executed on a pre-tax or post-tax basis.

PDPs may be established with various third-party benefit providers/vendors based on a payroll services agreement authorized by the employer and the employee. As such, benefits (e.g., goods and services) may be automatically purchased based on the deduction according to a defined schedule or on demand. Unfortunately, there is currently no convenient means of establishing a formal incentive program for employees based on the purchase of select items, such as lottery tickets, via payroll deduction. Still further, there is currently no system in place for managing and reporting the interaction between third-party providers, employers and employees regarding the purchase of said items as an employer sponsored benefit.

Based on the foregoing, there is a need for facilitating and monitoring transactions associated with the purchase of employer sponsored benefits and/or incentives.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for facilitating and monitoring transactions associated with the purchase of employer sponsored benefits and/or incentives, according to one embodiment;

FIG. 2 is a diagram of an incentive platform, according to one embodiment;

FIGS. 3A-3E are flowcharts processes for facilitating and monitoring transactions associated with the purchase of employer sponsored benefits and/or incentives, according to various embodiments;

FIGS. 4A-4G and 5A-5E are diagrams of user interfaces for facilitating and monitoring transactions associated with the purchase of employer sponsored benefits and/or incentives, according to various embodiments;

FIG. 6 is a diagrams of a user interface for reporting transactions associated with the purchase of employer sponsored benefits and/or incentives, according to on embodiment;

FIG. 7 is a diagram of a computer system that can be used to implement various exemplary embodiments; and

FIG. 8 is a diagram of a chip set that can be used to implement an embodiment of the invention.

### DESCRIPTION OF THE PREFERRED EMBODIMENT

An apparatus, method and software for facilitating and monitoring transactions associated with the purchase of employer sponsored benefits and/or incentives is described. In the following description, for the purpose of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to the purchase of lottery tickets, it is contemplated that these embodiments have applicability to the acquisition of any items made available for purchase by a vendor, service provider or the like with respect to an employer. This may include, for example, items such as raffle tickets, coupons, gift cards, consumer goods, consumer services, etc. Still further, the exemplary embodiments may pertain to any type of service provider, including those that provide items or benefits requiring purchase confirmation, revenue/taxation reporting or post purchase results reporting. For the purpose of illustration herein, a benefit may include any item, incentive or the like made available for purchase by an employee per an employer sponsored and defined incentive program.

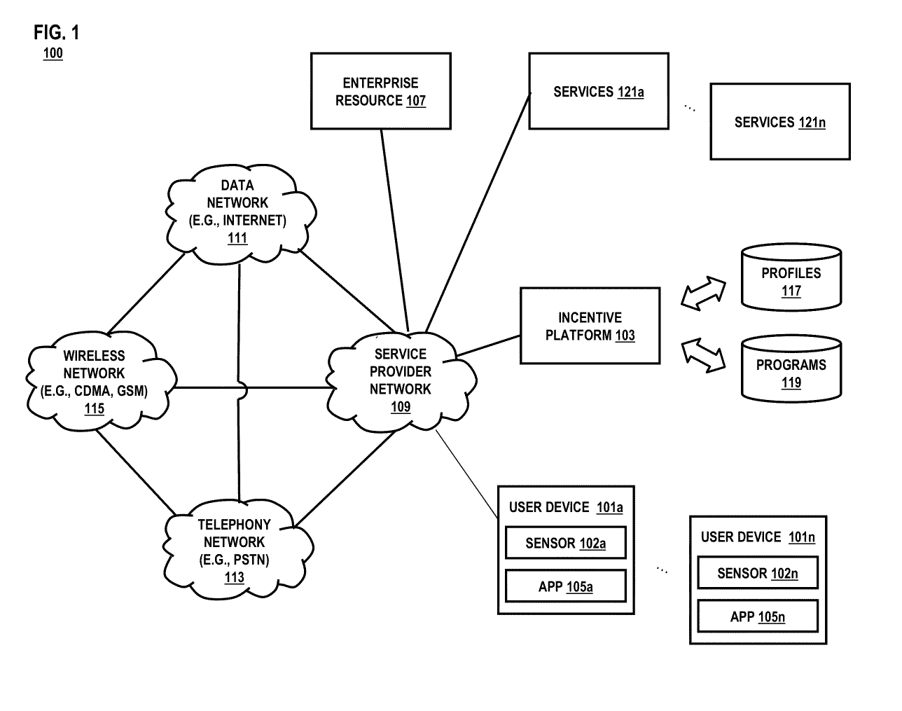

FIG. 1 is a diagram of a system for facilitating and monitoring transactions associated with the purchase of employer sponsored benefits and/or incentives, according to one embodiment. The system 100 is shown to include one or more user devices 101a-101n (e.g., mobile devices, smart phones, netbooks, laptops, or any communications enabled computing devices). By way of example, the user devices 101a-101n (referred to herein collectively as user devices 101) may belong to one or more employers or employees (e.g., users) as personal or work related devices. As will be discussed further, the user devices 101 may be configured to communicate with an incentive platform 103 for facilitating the purchase of items in accordance with an incentive program 119 or benefit scheme of the employer.

As noted previously, employers are often looking for creative ways to incent their current employees for their service and participation in the activities of the organization. Still further, the offering of incentives may be useful for attracting the best potential hires. Traditional benefit programs include, for example, retirement programs, healthcare benefits, gym membership discounts and other incentives; all of which are intended to attract and retain the best employees. Usually, these benefits are arranged by the employer, with the permission of the employee, according to a payroll deduction program (PDP). PDPs enable an amount of the employee's compensation to be automatically deducted from their paycheck on a regular basis for the purpose of fully or partially funding the benefit. Employers may establish PDPs with different vendors or service providers, including dry cleaners, child care providers or the like as a convenience/incentive to employees. In some instances, employees may themselves establish a PDP arrangement with a service provider of their choosing by completing enrollment forms and having the forms authorized by their employer.

Some employees take it upon themselves to create programs as a group. For example, employees may organize a lottery pool, a fantasy football league, a gifting program, or other self-regulated activity wherein the participation is voluntary and intended to benefit the group as a whole. In the case of the lottery, for instance, the employees may each contribute an amount of money to be used for the purchase of a number of tickets and numbers to play. The winnings, if any, may then be shared amongst the participants equally or in proportion to their amount of contribution to the ticket purchases. The group interaction and sense of anticipation can be exciting to the individuals within the group.

Unfortunately, there is currently no employer centric system for incentivizing and promoting the participation of employees in the acquiring of select third-party items, such as lottery tickets, as an employer sponsored benefit (incentive). Resultantly, the excitement and anticipation caused by individual or group purchasing of said benefits (incentives) is not directly associated with the employer; thus preventing employers from actively leveraging this purchase activity. Moreover, states and other service providers are unable to capitalize on the desire of employees, and thus tax payers, to purchase goods and services that may stimulate the local economy.

Still further, there is currently no convenient means of managing the end-to-end transactional details and reporting requirements associated with the purchase of third-party benefits and incentives, such as lottery tickets. For example, while cash prizes, lottery winnings or items of higher value are expected to be reported to a tax authority, this is not always the case for smaller sums or items deemed to be of lesser value. Consequently, states that sell lottery tickets are unable to associate ticket purchases and winnings of lesser amounts with a specific purchaser for tax reporting purposes. Resultantly, the amount of tax revenue collected by the tax authority is limited.

To address this issue, system 100 presents an incentive platform 103 that is configured to interact with one or more user devices 101a-101n, referred to herein collectively as user devices 101. The user devices 101 may interact with the incentive platform 103 by way of an application 105a-105n, referred to herein collectively as applications 105, to facilitate the purchase of third-party benefits as sponsored by an employer. For the purpose of illustration, the user devices 101 may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), smartphone or any combination thereof. It is noted that the user devices 101 may support the execution of different operating system(s) and hardware command functions. In addition, various network communication, data exchange and graphic interface executions may be performed in conjunction with the applications 105, the operating system(s), etc.

The incentive platform 103 may be utilized by the employees via user devices 101 based on usage policies and/or reward criteria established by the employer (i.e., as an incentive program 119). As such, the incentive platform 103 serves as a system for managing and facilitating the purchase of the third-party benefits from providers of services 121a-121n (referred to herein collectively as services 121). Purchases may be executed according to a payroll deduction program (PDP) or other funding arrangement as per the incentive program of the employer. Still further, the incentive platform 103 may facilitate the monitoring and reporting of transactional details associated with the purchase of the services 121. As such, the incentive platform 103 may generate reports, alerts and documentation associated with the initial purchase, the delivery and procurement of the services 121, or other activities related to the purchase. This may include the reporting of winnings associated with a purchase of services 121 involving a lottery, a sweepstakes or a raffle. For the purpose of illustration, the incentive platform 103 may be offered as, or in connection with, an incentive program of the employer for motivating, rewarding or otherwise incentivizing employees.

In one embodiment, the incentive platform 103 may be implemented as a managed, hosted or cloud-based solution made available to employers and employees by way of a communication network, i.e., service provider network 109. By way of example, employers may register with the incentive platform 103 for enabling the management, procurement and execution of an incentive program based on the purchase of benefits or items offered as services 121. The incentive platform 103 may generate a user interface for enabling the enrollment/registration of employers via a web browser, a network portal or other application 105 of the user device 101. Under this scenario, the employer may enter a uniform resource locator (URL) into the application 105 to acquire the network location of the incentive platform 103 and initiate the registration.

In one embodiment, the registration procedure may include the establishing of an employer profile at a profile database 117 for specifying details regarding the employer. The profile information may specify, for example, employer contact and address information, the number of employees associated with the employer, a tax or corporate entity status of the employer, an employer identifier or corporate tax identifier, network address and internet protocol information for the employer, email address information, primary contact persons or key administrators of the employer, and the like. In addition, the registration procedure may require the employer to establish login credentials, such as a username and password, for enabling subsequent access to the incentive platform 103. It is noted that the login credentials may be maintained by the incentive platform 103 for enabling subsequent referencing, retrieval and updating of the employer profile in the profile database 117.

In one embodiment, the incentive platform 103 may also be configured to interact with an enterprise resource 107 of the employer. The interaction may be performed during initial registration or subsequently, such as during the updating of an existing employer profile, the establishing of an employee profile, or the like. Per this interaction, the incentive platform 103 may acquire pertinent information for generating the employer profile directly from the enterprise resource 107. By way of example, the enterprise resource 107 may include a human resources management system, an employee management system, an enterprise resource planning system, a capital management system, a business intelligence system, a financial management system, an accounting system, a payroll processing system, or the like. Alternatively, the enterprise resource 107 may include one or more data stores for housing profile information regarding the employer. Regardless of the resource type, the employer profile information or portions thereof, may be retrieved from one or more of these systems based on the appropriate access credentials.

Under this scenario, the incentive platform 103 may present the employer with an option to login to the enterprise resource 107 and retrieve the data accordingly. For example, the user interface of the incentive platform 103 for performing the registration may present a link or button for enabling remote access to the enterprise resource 107. The employer may be prompted to enter their login credentials, submit one or more security tokens, or provide other identification information for connecting with the enterprise resource 107. Per this execution, the incentive platform 103 may execute one or more application programming interfaces (APIs) for accessing the enterprise recourse 107 or may be directly integrated with the enterprise resource 117. The embodiments herein contemplate any known and still developing implementations.

In one embodiment, the incentive platform 103 may also interact with the enterprise resource 107 for performing validation and/or authentication of the employer (or employees thereof). For example, in the case of initial registration of an employer, successful access to the enterprise resource 107 and credentials of the employer may be required the incentive platform 103 to validate the employer registration, the status of the employer as a registered entity (e.g., organization or business) within a state of domicile, etc. Similarly, an employee may be validated as being affiliated with an employer.

In one embodiment, the incentive platform 103 may also present data for indicating a projected or actual cost to the employer, the employees or a combination thereof for purchasing benefits or items made available as services 121. The total cost information for the employer may be determined based on numerous factors, including the number of employees specified or expected to participate, the cost per item or benefit (e.g., cost of services 121), the number of times to purchase the benefit or item, the frequency of purchase, etc. Under this scenario, the calculated cost for a number of employees may be determined as follows:

Total Cost to Employer (For a Specified Period)=Cost Per Item*No. of Purchases (Per Period)*No. of Employees

It is noted that the above described calculation is based on the assumption of funding of the benefit in whole by the employer. Alternatively, the actual cost to the employer may vary depending on the amount of money contributed to the purchase via a payroll deduction as permitted by employees. As will be discussed further later one herein, the payroll deduction may be authorized by the employer per a payroll deduction program and required for enabling participation of the employee. The actual cost to the employer, therefore, is reduced based on the expense incurred directly by the employee towards the purchase. Under this scenario, the calculation may be determined as follows:

Actual Cost to Employer (For a Specified Period)=Total Cost=Payroll Deduction Contributions

By way of example, in the case where an employer specifies 10 employees to participate in the purchase of an item that costs $2, a purchase frequency of once per week would result in a monthly cost to the employer of $80. Per this same scenario, the actual cost to the employer would only be $40 in the case where employees execute a $40 payroll deduction. This may correspond to policies and/or criteria of the incentive program 119 for indicating an employer match of funds contributed by the employees. Alternatively, the actual cost incurred by the employer may be zero when the policies and/or criteria indicate the employer makes no contribution to the purchase of services 121.

Regardless of the approach chosen, the incentive platform 103 enables an employer to run different scenarios before they initiate an incentive program in order to determine a best fit. It is contemplated, in future embodiments, that use of the incentive platform 103 by employers may result in a tax break to the employer. Under this scenario, an employer actively enrolled with the incentive platform 103 may receive the tax break as a result of designing an incentive program 119 around the purchase of services 121 offered by the state (e.g., lottery items). As such, contributions by the employers may also be subject to different taxation. As such, the incentive platform 103 may also present the actual or estimated cost information with respect to any tax breaks that may be due the employer. Still further, the incentive program may also calculate the costs based on known tax rates for the applicable state of the employer and/or employee or other factors. It is noted that the tax break may be subject to applicable state legislative action, permissions of an appropriate tax authority, etc.

In one embodiment, the incentive platform 103 enables an employer to design and implement an incentive program 119. This may correspond to a programming execution of the incentive platform 103, wherein the employer establishes parameters, rules and/or criteria (e.g., program information) for defining the incentive program or scheme. In addition, the employer may specify one or more employees or groups thereof that are eligible to partake in the incentive program 119 as designed. In the case of the latter, the employer may indicate the eligible employees and the employees may subsequently enroll with the incentive program 119 to indicate they want to participate. By way of example, the incentive platform 103 may render a configuration interface to the application 105 accordingly for generating/designing the incentive program 119. Hence, the configuration interface may present various data entry fields, buttons, menus or the like for enabling the employer to select options for configuring the incentive program.

By way of example, one configuration option may include specifying a provider of a service 121 to provide to employees as an incentive. Per this option, one or more registered or affiliated providers of services 121 may be presented to the employer via the configuration interface via the application 105. The employer may select a specific provider from a list of providers of services 121. In addition, the configuration interface may enable the employer to select one or more items, benefits or the like that may be offered to the employees. For instance, in the case where the provider is a state lottery service, the employer may select the lottery provider as well as select from an array of games available for play or purchase. Each game may correspond to a particular ticket or drawing type, with varying prices depending on the selection. In another scenario, where the provider is a raffle service, the employer may select the raffle provider as well as select from amongst the different drawings/prizes being offered.

Another configuration option for establishing the incentive program may include enabling the employer to specify a purchase budget. For example, the purchase budget may correspond to an amount of funds made available for the purchase of services 121 offered by a provider. The employer may indicate this value as an upper spending limit and may further indicate an employee contribution amount or limit, a bonus/employer contribution amount, or a combination thereof. For example, in the case where the provider is a state lottery service, the employer may specify an amount of money to be made available by the employer for the purchase of lottery tickets. This may correspond to an employer funds pool or bonus pool—i.e., a source of funds allocated directly by the employer for the purchase of services 121 for an employee.

The employer may also indicate a maximum amount of money capable of being used by the employee for the purchase of services 121 via the incentive program. As will be discussed further later on herein, funds may be deducted from the wages of an employee via a payroll deduction. It is noted that certain restrictions, laws or rules may be applied for establishing the employer or employee contribution limits depending on the state of domicile of the employer or employee, a tax authority to which the employer or employee is beholden, municipality regulations, etc.

By way of example, the employer may also establish the quantity of services 121 (benefits and/or items) to be made available for purchase by employees. This may correspond to an upper numeric limit of benefits and/or items capable of being purchased from a provider of services 121. Moreover, the employer may specify the frequency of purchase of services 121, which may include a maximum or minimum number of purchases capable of being made in a given timeframe. For example, the employer may specify that a max of 100 lottery tickets be made available per the incentive program 119 and that employees be limited to participating in two drawings per week. Alternatively, select employees may be able to participate in more drawings or purchase/acquire more tickets than other employees.

Still further, in the case of a lottery service provider, the employer may indicate that employees must participate in a minimum number or frequency of drawings per week or month in order to participate in the employer sponsored incentive program. Alternatively, the employer may establish a default number of drawings or frequency of tickets to be purchased. Under this scenario, a default number of drawings or tickets per week of two as set may be adapted by the participating employee accordingly to a lesser or more frequent extent of participation or purchase on a discretionary basis. Hence, it is noted that participation in the incentive program by the employee may vary depending on a participation level and/or associated criteria thereof established by the employer (or an employee group).

Also, in certain embodiments, the incentive platform 103 may present the employer with metrics or figures for indicating the projected qualitative and/or quantitative outcome of a selected service 121 based on the established configurations. The metrics or figures may include, for example, an estimated increase in employee satisfaction expected to be achieved by the employer from implementation of an incentive program 119. This estimate may be based on data such as historical employee satisfaction information for the employer or other employers, state or industry related data, crowd sourced information as gathered from various social networking services or from internal sources (e.g., employee feedback), etc. As another example, the incentive platform 103 may present the employer with an estimated or actual cost of an incentive program 119. Under this scenario, the estimated or actual cost figures may be determined based on input provided by the employer for indicating a projected or actual number of employees to be enrolled in the incentive platform 103. Still further, the estimate or actual cost may be calculated based on the frequency of purchase, the quantity of items of benefits to be purchased, etc. It is noted that the cost information may be presented as a means of enabling the employer to evaluate the cost and/or potential benefit of an incentive program 119 or adapt an incentive program 119 accordingly.

Other criteria, rules and conditions may be further established based on the unique needs of the employees and the employer. In addition, the design of the program will vary depending on the type of services 121 available for selection by the employer for inclusion as a benefit. As such, the incentive platform 103 may be configured by employers with respect to one or more services 121 accordingly to account for different incentive programming needs. Once established, the incentive program is then maintained in a program database 119 and directly associated with a profile of an employer.

In one embodiment, the incentive platform 103 also enables the employer to associate employees with an established incentive program. By way of example, the incentive platform 103 enables the employer to establish an employee profile for a given employee. The employee profile may be maintained in the profile database 117 and may include employee contact and address information, employment status (e.g., active, inactive) and title information, network address and internet protocol information for the employee, email address information, department or group affiliation information, or the like. Still further, the employee profile may specify a participation level, such as a merit level, a bonus level, an employee ranking or the like for validating the eligibility of the employee to participate in an incentive program 119.

It is noted that the employer may generate the profile information manually, such as by way of a data entry process via a user interface generated by the incentive platform 103. Per this scenario, one or more fields may be populated by the employer for defining the employee profile. Alternatively, the incentive platform 103 may access the enterprise resource 107 of the employer—i.e., per a connection or login process—as a means of acquiring relevant information regarding the employee for generating the employee profile. Once generated, the employee profile may be subsequently linked to a unique registration identifier for subsequent recall of information regarding the employee. As will be discussed further later on herein, the unique registration identifier may correspond to an employee identifier, social security number, or the like for enabling the employee to consent to, and register for, participation in an incentive program 119.

In one embodiment, the incentive platform 103 enables assignment of a participation level to an employee. The participation level may be assigned on a discretionary basis as a means of encouraging employee participation in the incentive program as well as to recognize employees on the basis of performance, merit, or other factors. Alternatively, the incentive platform 103 may be configured to assign a participation level to an employee based on criteria established by the employer. Per this approach, the participation level may be continually updated based on interaction between the enterprise resource 107 of the employer with the incentive platform 103, subsequent updating of the employee profile, or a combination thereof.

For example, in one embodiment, the participation level may be associated with an employee based on tenure or seniority. As such, the employer may establish criteria for indicating a participation level with a certain number of years of employment; with higher participation levels being associated with higher years of employment. Per this approach, a first employee having two years of employment would be assigned a lower participation level than a second employee having ten years of employment. As another example, the participation level may be associated with an organizational rank of an employee, wherein a higher rank corresponds to a higher participation level. Under this approach, an employee whose employment title or rank is that of Vice President may be assigned a higher participation level than the rank of Supervisor.

The participation level may also be assigned based on evaluation results or production results attributed to an employee. For example, a highest participation level may be associated with an evaluation report generated by the employer regarding an employee. Per this approach, an employee that receives a favorable evaluation may be incented with a higher participation level. Similarly, a favorable production report—i.e., an amount of sales, revenue, manufacturing output, recruiting—may result in the employee being incented with a higher participation level. The incentive platform 103 may be configured to receive and subsequently analyze these reports based on the interaction between the enterprise resource 107 and the incentive platform 103. Alternatively, the report or key information from the report may be associated with an employee profile stored to the profile database 117. As such, the incentive platform 103 may support near real-time updating of the participation level of an employee based on the generation or updating of reports.

Still further, the participation level may be associated with a frequency or amount of purchase of a service 121 by an employee. For example, an employee that regularly purchases tickets offered by a provider of a lottery service on a recurring basis may be assigned a higher participation level than an employee that purchases the same items on occasion. Similarly, an employee that purchases a higher dollar value of tickets (as an employer sponsored benefit) may be assigned a higher participation level than an employee that purchases fewer tickets. The incentive platform 103 may be configured to persistently monitor the number and frequency purchase based on transactional engagement with the transactional systems of the providers of services 121. In addition, the incentive platform 103 may monitor payroll deduction program activity between the employee and the provider of the services 121.

While the aforementioned approaches are based on an employer assigned participation level, the incentive platform 103 may also enable employee assignment of participation levels. The employee assignment may be subject to authorization by the employer—i.e., the employer may set limits on the number of levels/points/tiers the employees may assign to one another. By way of example, the employer may allow employees belonging to a particular department or group to manage the assignment. Under this scenario, a group of employees belonging to the “Shipping Department” may assign participation levels to individual members of the group as they see fit to within the limits established by the employer. The assignment may be presided over by a primary representative of the group (e.g., the founder of the group, lead manager, department head) or may be allowed for assignment based on a consensus/group vote procedure (e.g., a majority vote for increasing a participation level of a summer intern based on merit).

As another example, the participation level may be assigned to the group as a whole, such as in the case where the service 121 upon which the incentive is designed is amenable to group participation and/or purchase (e.g., a group lottery ticket pool or purchase). It is further contemplated, in certain embodiments, that the incentive platform 103 may provide a user interface to the user devices 101 of employees for facilitating the assignment of participation levels. More regarding the individual and group interaction and engagement of employees with the incentive platform 103 based on a defined incentive program 119 of the employer will be discussed further later on herein. Regardless of the implementation, participation levels may be specified for affecting the level of interaction and/or receipt of benefits by an employee per a defined incentive program 119. Furthermore, the different participation levels and means for achievement thereof may be actively promoted by the employer for motivating, recognizing and rewarding employees.

It is noted, in one embodiment, that the participation levels may correspond to a particular classification or tier (i.e., Bronze, Silver, Gold or Platinum or Tier 1, Tier 2 or Tier 3). Also, the participation level may correspond to a number of points or units, where the accumulation of points or units corresponds to an increase in the participation level. Hence, the employer may establish thresholds for defining the number of points, units and/or corresponding tiers for a particular participation level. Under this scenario, for example, 1-100 points may correspond to a “Bronze” participation level, 101-200 points to a “Silver” participation level, etc.; with each point and/or unit being associated independently or in combination with the seniority, rank, purchase activity, performance, or other of the aforementioned factors/criteria established by the employer. Hence, points and/or units may be accumulated on the basis of multiple factors/criteria or an independent set thereof.

In one embodiment, the incentive program 119 may be configured to translate the assigned participation level into an amount of money set aside by the employer for the purchase of the benefit or item (e.g., service 121) for the employee and/or group thereof. This may correspond to a purchasing of the service 121 outside of any direct payroll deduction program arrangement authorized by the employer for the benefit of an employee. For example, the employer may set aside a pool of funds to be used for matching the tickets purchased by an employee via a PDP arrangement. Still further, the incentive program 103 may stipulate criteria for executing the purchase match, i.e., 10% growth in work productivity of the employee, the meeting of a project deadline by the employee's team or department, the successful completion of an organizational goal, etc. Various custom scenarios may be executed by the incentive platform 103 as design constraints and/or programmatic triggers of the incentive program 119.

In one embodiment, the incentive platform 103 performs one or more enrollment actions. For example, the employee may access the incentive platform 103 via the application 105 to determine if they or their employer are actively enrolled with the incentive platform 103. Employee participation in the incentive program 119 is contingent upon successful registration of the employer with the incentive platform 103, the defining of an incentive program 119 and selection of the employee for participation in the program. In the case where no incentive program 119 is defined or the employee is not yet selected (e.g., employee profile not yet generated), the incentive platform 103 may facilitate transmission of a message to the employer requesting an incentive program be established or that the employee be enrolled. The message may be transmitted at the request of an employee as a means of encouraging the employer to offer one or more services 121.

In the case where the enrollment of the employer is confirmed, the employee may then elect to participate in the established incentive program 119 of the employer. Under this scenario, the employee may be presented with details regarding the different incentive programs 119 being offered and the benefits and/or advantages thereof. The details may include information regarding the different providers and services 121 (e.g., items and/or benefits available), participation options available to the employee, group availability, etc. The employee may also be presented with various buttons (e.g., an ENROLL action button), data entry fields, or other input options for indicating they want to enroll in the program.

It is noted, in certain embodiments, that employee participation may also correspond to an agreement to opt-in to the sharing of transaction information regarding their participation in the incentive program 119 with the employer, the provider of the services 121, or a combination thereof. The opt-in agreement may be subject to specific terms, consumer information provisions, privacy laws and the like. Still further, the opt-in agreement may also require the express consent of the employee to participate in the purchase of services 121 via the incentive program 119 by way of a payroll deduction program (PDP). It is contemplated, in certain embodiments that a lack of consent may result in a denial of enrollment of the employee in the incentive program 119.

In one embodiment, the incentive platform 103 may facilitate the establishment of the payroll deduction program (PDP) for purchasing services 121 per an established incentive program 119. The PDP may be executed by the provider of services 121 directly or facilitated by way of a third-party payroll deduction services vendor. In certain implementations, the PDP may be setup automatically based on the consent of the employee (e.g., per the opt-in). In this case, the incentive platform 103 may interact with the enterprise resource 107, the providers of services 121, or a combination thereof to facilitate employment verification, deduction reporting and integration of the provider of services 121 with an existing payroll processing system or scheme associated with the employee. Alternatively, the employee may presented with one or more registration data entry fields for establishing the PDP and obtaining authorization of the employer. In either case, the PDP may be classified as a voluntary deduction, wherein monies deducted for the purchase of services 121 are withheld from the employee's paycheck on a pre-tax or after-tax basis. The tax classification for the deduction will vary depending on the type of benefit being offered via the incentive program 119.

In one embodiment, the employee may also establish which items and/or benefits they wish to purchase and the frequency of purchase. By way of example, the employee may be presented with one or more selection options (e.g., buttons or checkboxes) for indicating an item and/or benefit of interest. As such, in the case where the items and/or benefits are offered by a lottery service provider, the employee may select amongst the different drawings/ticket types available. In addition, the employee may choose to participate in the default number of weekly drawings (e.g., two) established by the employer, a custom number of drawings (e.g., one), or a manual number of drawings (e.g., on demand purchase option). In the case where the items and/or benefits are offered by a sweepstakes provider, for example, the employee may select from the different sweepstakes drawings that are included for participation via the incentive program 119. Regardless of the array of services 121 offered by the provider, the incentive platform 103 enables the presentment of only those items and/or benefits selected for inclusion in the incentive program 119.

In one embodiment, the above described selections made by the employee during the enrollment process are saved to the employee profile and stored at the profile database 117, thus signifying successful enrollment of the employee for participation in the incentive program 119. Once completed, the employee may then be presented with a message at the user interface of the application 105, an email notification, a text message, or the like for confirming their enrollment and participation status. Resultantly, the employer may proceed to edit their enrollment settings or perform other actions, such as select numbers they'd like to play in the case of a lottery service, identify other groups to participate in, found a new group, etc.

It is noted, in certain embodiments, that the above described enrollment procedure and/or access to the incentive platform 103 by an employee may be contingent upon various security and/or authentication requirements established by the employer. This may include, for example, the ability of the user device 101 of an employee to locally or remotely access an internal network of the employer. In this way, only those devices 101 that are recognized by the internal network (e.g., service provider network 109) may access the incentive platform 103. Moreover, the enrollment process may require an employee login, wherein the login credentials include the employee identifier, the social security number or other pertinent security credentials. The employee may also be required to provide an employer issued identifier or credential, such as one generated during selection of the employee by the employer for participation in the incentive program 119.

Still further, accessing of the incentive platform 103 by an employee may be based on the analysis of contextual information gathered by various sensors 102 of the user device 101. The contextual information may include location information, biometric data regarding the employee, temporal information, network signal information, or the like. By way of example, location information (e.g., geospatial coordinates) gathered by the sensors 102 may be acquired and subsequently transferred to the incentive platform 103 for analysis. The location may then be validated by the incentive platform 103 to determine if it matches known location and/or proximity information regarding the employer. It is contemplated that the incentive platform 103 may enable the execution of various other authentication, security or access approaches for facilitating enrollment of an employee.

In one embodiment, the incentive platform 103 monitors all purchases made as well as any other transactional occurrences initiated per the incentive program 119. As such, the incentive platform 103 collects data generated as a result of the interaction between the employee and the provider of the services 121 from the point of initial registration, the point of purchase and onward through order fulfillment and placement. For example, the incentive platform 103 may track/monitor: the delivery of the items and/or benefits as ordered, the occurrence of winnings (e.g., in the case of a raffle, lottery or sweepstakes), subsequent adaptations in employee participation levels (e.g., group affiliations, purchase frequency), subsequent adaptations in employer sponsorship, etc. Hence, the incentive platform 103 facilitates end-to-end monitoring and tracking of the transactions/activities engaged by the employee as they participate in, and take advantage of, the incentive program 119. It is noted that the incentive platform 103 may execute one or more instructions for persistently communicating with various servers, data stores (e.g., cloud services), data portals, or the like associated with the providers of services 121 for acquiring relevant data associated with the purchase lifecycle.

It is noted that the number of providers and benefits capable of being selected will vary depending on which services 121 are associated with the incentive platform 103, the type of items or benefits available, etc. In one embodiment, the providers of different services 121 may also register/enroll with the incentive platform 103 accordingly, such as to facilitate the exchange of relevant information and to enable the tracking/monitoring of transactions in association with an incentive program 119. The provider of a service 121 may establish a service provider profile at the profile database 117 for indicating their interest in the providing items or benefits (e.g., services 121). Under this scenario, the service provider profile may specify contact and address information, network address and internet protocol information, email address information, primary contact persons or key administrators, and the like. In addition, the service provider profile may specify which of the various items or benefits are to be made available for inclusion within an incentive program 119 for employers, textual or graphic descriptions of the items or benefits, cost information regarding the items or benefits, delivery or order fulfillment details, payroll deduction program configuration instructions, etc.

In another embodiment, the provider of a service 121 may also specify one or more predetermined programs to associate with the service provider profile. The predetermined program may be an incentive program designed/created by the provider that is made available to one or more employers registered with the incentive platform 103. As such, a registered employer may select a predetermined program offered by a provider of a service of interest, such as during initial registration or design of an incentive program 119. By way of example, a provider of a lottery service may feature a program entitled “Pick 4 Weekly,” wherein a weekly drawing for a game involving the selection/guessing of four numbers is played once a week on a specific day. As another example, a provider of a sweepstakes may offer a program entitled “Cash Four Days,” wherein a cash raffle drawing is conducted four days a month.

Regardless of which predetermined program is selected, the employer may adapt the program at their discretion, based on permissions afforded by the provider of the services 121. For example, in the case of the aforementioned predetermined program entitled “Pick 4 Weekly”, the employer may have permission (as granted by the provider of the service 121) to alter the frequency of play. As another example, the employer may have permission to alter the name of the predetermined program while maintaining the basic configuration of the program. So, for example, the employer may adapt the name “Pick 4 Weekly” to be “Company A Lotto Play” or any other title. It is noted, therefore, that providers of services 121 registered with the incentive platform 103 may present various convenience and customization options to registered employers. These convenience and customization options may be provided to increase the likelihood of selection of the provider's services 121 in the design of an employer sponsored incentive program 119.

In one embodiment, the incentive platform 103 may also facilitate communication between various employees enrolled to participate in an incentive program 119 sponsored by an employer. Under this scenario, messages may be exchanged between employees or group members regarding purchases, the services 121, etc. In the case, for example, where the incentive program 119 is associated with the purchase of lottery tickets, employee group members may exchange chat messages regarding an upcoming drawing or share a countdown timer with one another regarding the announcement of the numbers/winnings of the day. As another example, the employees may post messages to a message board regarding their participation or provide feedback information to the employer for indicating changes they recommend to the incentive program 119. Still further, the employees may provide rankings for indicating their satisfaction with the incentive program 119. It is noted that the employee may have the option of posting messages anonymously or selectively (e.g., group members only, entire company). Furthermore, ranking information or feedback information may be monitored and collected by the employer for use in evaluating the effectiveness of an incentive program 119.

In one embodiment, the incentive platform 103 generates reports regarding the transactions and interactions between employees, the employer or the different providers of services 121 as a result of the incentive program 119. The reports may be presented to the user interface of the application 105 as messages or transmitted via email, short messaging service (SMS) or the like. By way of example, a report for specifying the participation of an employee or groups thereof may be presented to the employer, the employee or the different employee group members. The report may indicate the participation levels of the employee(s) along with data for comparing the participation levels of other employees of the employer. Also, the report may provide data for comparing the participation levels of employees by region or territory, such as in the case where an employer conducts business in different locations. Still further, the report may compare the participation levels of the employees of one employer versus those of another employer, such as to encourage friendly competition.

As another example, a report may be presented for indicating the popularity of different services 121 associated with an incentive program 119. Under this scenario, feedback information and/or ranking information regarding the incentive program 119 may be presented on an employee, group, departmental or regional basis. In yet another example, an order fulfillment report may be generated for indicating the number of items and/or benefits delivered as purchased via the sponsored incentive platform 103. In the case where the items and/or benefits are offered by a lottery service provider, the report may include a tabulation of tickets purchased and winnings received for a period of time (e.g., year-to-date, month-to-date, for the week). Also, a winnings report or message may be presented to the winning employee or group thereof for indicating the amount won, claims filing, payout options, tax implications, etc. Hence, reports regarding activities from the time of initial purchase all the way through to delivery and procurement of winnings, may be reported accordingly via the incentive platform 103. As such, winnings, prizes or other outcomes or results pursuant to the initial purchase of a service 121 may be properly monitored and reported regardless of the value of the winnings.

As another example, the incentive platform 103 may also generate financial reports associated with the purchase of items and/or benefits per an employer sponsored incentive program 119. This may include, for example, a report for indicating the number and amount of payroll deductions performed against employee earnings. In addition, a cost report may be generated for indicating the expenses incurred by the employer in providing the incentive program 119 to enrolled employees. This may include a tabulation of the total amount of funds provided by the employer for matching purchases made by employees.

Still further, a tax report may be generated by the incentive platform 103 in connection with the procurement of an item and/or benefit purchased via an established incentive program 119. This may correspond to the reporting of winnings or other prizes, such as in the case where the items and/or benefits are lottery or sweepstakes related. The report may be a tax form as required by a state or federal tax authority for reporting gambling income. By way of example, per the Internal Revenue Service of the United States, Form W-2G is used to report income and withholdings. Typically, Form W-2G is required to be filed with a tax authority when the following conditions are met, as indicated in Table 1 below:

TABLE 1

$600 or more in gambling winnings and the payout is at least
300 times the amount of the wager (except winnings from
Bingo, Keno, and slot machines);
$1,200 or more in gambling winnings from bingo or slot machines
$1,500 or more in proceeds (the amount of winnings less the
amount of the wager) from Keno
Any gambling winnings subject to federal income tax withholding

It is noted, however, that the incentive platform 103 may generate reports for specifying winnings of any amount, including those less than the mandated threshold for reporting (e.g., $600). It is also contemplated, in certain embodiments, that the reports may be automatically generated, reported or filed by the incentive platform 103 on behalf of the employee. This may include, in the case of the IRS, generation of W2, 1099 and other required tax forms and reports. Moreover, said reports may be directly transmitted to the appropriate tax authority in association with the name, social security number, tax identifier, employer/employee identifier or other relevant information. Alternatively, the reports may be maintained by the incentive platform 103 in association with the profile of the employee for subsequent retrieval, stored by the enterprise resource 107 in connection with the employee, or a combination thereof. In the latter case, said reports may be submitted to the employee by the employer along with other tax and wage reporting statements, such as W2 forms, during the reporting period.

In one embodiment, the incentive platform 103 enables reports to be customized for the intended recipient. As such, content presented in a report may vary based on the context and/or recipient that will receive said report. For example, metrics of interest to an employer such as participation level growth rates by department or region or productivity-to-incentive expense ratios, may be of little to no interest to employees. Similarly, reports regarding winnings and tax revenue generation may be of limited interest to employees, but pertinent to company executives or the tax authority itself. Moreover, the reports may feature various metrics, graphs and images in addition to the presenting of textual and/or numeric data. Hence, the incentive platform 103 may support report customization, i.e., via the selection of report characteristics, data filter definitions, data processing and extraction models, etc. The level of access to certain data and the corresponding level of customization may be established by the employer, i.e., permission based data access or customization).

Still further, reports may be filtered and processed at the discretion of a recipient, such as by way of one or more filtering options presented to the user interface of the application 105. Alternatively, one or more reporting settings may be established by a recipient, thus enabling them to hone in on specific data sets and determine specific results (e.g., based on access or customization permissions/limits). Under this scenario, the data may be filtered by data type, composition, or according to any other known data extraction or data mining techniques. Also, the reports may be processed according to any known or still developing analytic algorithms or computational scenarios. Hence, different algorithms and computational scenarios may be provided as programmatic instructions during the design of the incentive program 119. As such, the algorithm may be triggered for execution based on the meeting of certain criteria. Likewise, the frequency of reporting may be established.

The above described interaction, monitoring and reporting approaches of the incentive platform 103 present several advantages. For example, as one advantage, the incentive platform 103 ensures all purchases and subsequent transactions, including winnings of lesser amounts, are persistently monitored and associated with a specific tax paying user. As such, identifying information for a given person (e.g., an employee)—i.e., a tax identifier, social security number, employee identifier—is maintained throughout the transaction lifecycle. By facilitating end-to-end monitoring and tracking, pre and post purchase activities may be associated with a consumer/person/employee accordingly.

As another advantage, due to the aforementioned persistent monitoring, purchase transactions resulting in the provisioning of earnings/winnings, prizes of value, or the like may be accurately reported for tax purposes. This is in contrast to approaches where manual reporting of earnings is expected to be performed by the winner, such as in the case of lottery earnings below a certain amount (e.g., $600). In the case of manual reporting, some winners may not declare smaller winnings, resulting in a loss of tax revenue being generated for a given state or local economy.

As a result, the incentive platform 103 may drive an increase in tax revenue generation for a given state by enabling the tracking of winnings of all amounts. In addition, revenue gains may be further realized for a state or local economy as a result of enhanced participation of tax payers (e.g., employees and employers) in the purchase of services 121 (items and/or benefits). This is particularly evident in the case where an incentive program 119 is designed around a state based lottery service, as increased ticket sales translates into increased state revenue. This is in contrast to other measures of increasing state revenues such as the cutting of various state or municipal services, levying tax increases, etc. Also, as an employer-centric system and/or solution, the incentive platform 103 enables employers to actively foster such participation for their benefit, the benefit of their employees and the economy.

As yet another advantage, the incentive platform 103 supports the enrolling/registering/subscribing of employees in the purchase of services 121 on a recurring basis. As noted previously, recurring purchases may be established by way of a payroll deduction program (PDP) arrangement, thus corresponding to an established deduction amount and purchase frequency. Resultantly, providers of services 121 may accurately forecast sales and earnings for a given employee, group of employees, employer, industry, region, or other category based known enrollment. In the case of lottery services, this enables a state to forecast residual revenue, project future revenue based on projected participation level increases, make budgetary decisions based on current or future enrollment, etc.

As another advantage, the incentive platform 103 enables the tracking of employee participation levels for a given incentive program 119. Resultantly, employers may acquire data regarding the tendencies or needs of employees as well as determine the popularity of various services 121. In addition, vital feedback information may be gathered from employees in the form of suggestions, commentary of the like, for supporting incentive program 119 improvements to be made. It is contemplated, in future embodiments, that this information may be shared with the providers of services 121 as well for fostering continual improvement of services, negotiating the prices of services 121 (e.g., enrollment or participation level based discounts), etc.

Still further, as another advantage, the incentive platform 103 may interact with any known transactional or network based systems of a provider or employer for facilitating execution of an incentive program 119. By way of example, the incentive platform 103 may execute various application programming interfaces (API) for enabling seamless integration with an existing transaction or network based system of a provider of services 121. This may include, for example, APIs for supporting existing user interface executions of a provider of a service (e.g., a current ecommerce site of the provider) or for enabling purchases and back office processing. Still further, the incentive platform 103 may execute APIs for interacting with an enterprise resource 107, such as to acquire profile information from relevant data stores, to normalize or cleanse data, etc.

Hence, the incentive platform 103 may be configured as a third-party, operating system agnostic system or solution, capable of being fully integrated with existing systems of employers and/or providers of services 121. Moreover, the incentive platform 103 may serve as an independent facilitator of transactions between the providers of services 121, employees and employers.

In certain embodiments, user devices 101a-101n, the incentive platform 103 and other elements of system 100 may be configured to communicate via a service provider network 109. According to certain embodiments, one or more networks, such as data network 111, telephony network 113, and/or wireless network 115, can interact with the service provider network 109. Networks 109-115 may be any suitable wireline and/or wireless network, and may be managed by one or more service providers (e.g., communication service provider). For example, telephony network 113 may include a circuit-switched network, such as the public switched telephone network (PSTN), an integrated services digital network (ISDN), a private branch exchange (PBX), or other like network.

Networks 109-115 may employ various technologies for enabling wireless communication including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (Wi-Fi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Still further, the communication provider network may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, the communication network 105 may embody or include portions of a signaling system 7 (SS7) network, Internet protocol multimedia subsystem (IMS), or other suitable infrastructure to support control and signaling functions.

It is noted, though not shown in the figure, that in certain embodiments user devices 101a-101n may be configured to establish peer-to-peer communication sessions with each other, the incentive platform 103 and/or the enterprise resource 107 using a variety of technologies—near field communication (NFC), Bluetooth, ZigBee, infrared, etc. Also, connectivity can be provided via a wireless local area network (LAN). By way of example, a group of user devices 101a-101n may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 101, i.e., IP addresses that are accessible to devices connected to the service provider network 109 as facilitated via a router.

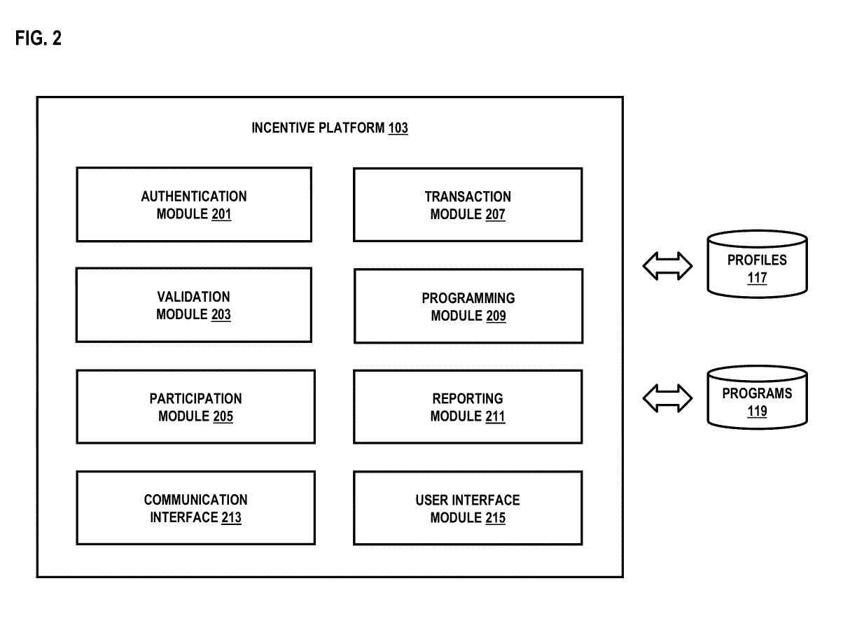

FIG. 2 is a diagram of an incentive platform, according to one embodiment. The incentive platform 103 includes various executable modules for performing one or more computing, data processing and network based instructions that in combination provide a means of facilitating and monitoring transactions associated with the purchase of employer sponsored benefits and/or incentives. Such modules can be implemented in hardware, firmware, software, or a combination thereof. By way of example, the incentive platform 103 may include an authentication module 201, a validation module 203, a participation module 205, a transaction management module 207, a programming module 209, a reporting module 211, a communication interface 213 or a user interface module 215. In addition, the incentive platform 103 also accesses profile data from a profile database 117 and program information from a program database 119.

An authentication module 201 authenticates users and user devices 101 for interaction with the incentive platform 103. The users requiring authentication may include employers, employees or providers of services 121. As such, different users representing different parties and needs may interact with the incentive platform 103 accordingly. By way of example, the authentication module 201 receives requests to enroll with the incentive platform 103. The enrollment process may include the establishing of profile settings, including user contact information, status information, identifier information and the like. In addition, one or more preferences or settings such as payroll deduction frequency and amount, benefit selection options, program offerings and/or participation preferences, or the like may be specified during enrollment. Preferences and settings information may be referenced to a specific user, user device 101, or a combination thereof and maintained as profile data 117.

It is noted that the type of profile information provided/required may vary depending on the context of the user. Thus, the authentication module 201 may operate in conjunction with the user interface module 215 to facilitate gathering of the necessary profile information. Under this scenario, the profile information is retrieved as input from the user by way of a questionnaire presented to a user interface of an application 105 in operation at the user device 101. Alternatively, the authentication module 201 may operate in conjunction with a validation module 203 in order to validate a relationship between the user and an enterprise resource 107. Per this approach, the authentication module 201 may retrieve the profile information from the enterprise resource directly over a communication network (e.g., service provider network 109).

The authentication process performed by the module 201 may also include receiving and validating a login name and/or user identification value as provided or established for a particular user during initial enrollment. The login name and/or user identification value may be received as input provided by the user from the user device 101 or other device via a graphical user interface, i.e., per user interface module 215. Established profile information 117 for respective users (e.g., employees, employers, providers of services 121 or representatives thereof) may then be cross referenced as part of the login process. Alternatively, the login process may be performed through automated association of profile settings maintained as profile data 117 with an IP address, a carrier detection signal of a user device, mobile directory number (MDN), subscriber identity module (SIM) (e.g., of a SIM card), radio frequency identifier (RFID) tag or other identifier. Still further, the authentication module 201 may also be configured to receive requests from various devices 101 for the downloading or activation of the application 105. Under this scenario, the application 105 may be downloading during, or as part of, the enrollment process. In addition, the authentication module 201 may determine a permission of the user to permit the receipt of information from sensors 102, which may be processed by the validation module 203 accordingly for determining whether certain contextual conditions are met.

The authentication module 201 may also enable the establishment of a payroll deduction program (PDP). By way of example, the PDP may be established with the provider of services 121 directly or by way of a third-party payroll deduction services vendor. Under this scenario, the authentication module 201 may determine a consent or opt-in status of the employee, wherein the opt-in corresponds to permission for establishment of the PDP. Still further, the authentication module 201 may operate in connection with the validation module 203 in order to access an enterprise resource 107. Alternatively, the authentication module 201 may operate in connection with the user interface module 215 for enabling user entry of information required to establish and authorize the PDP. Under this scenario, the user may be presented with one or more registration data entry fields for establishing permission of the employee to deduct funds according to a specific frequency.

Per the above described executions, the authentication module 201 and validation module 203 may perform employment verification, determine current payroll cycles, etc. In addition, the authentication module 201 and validation module 203 may validate an authorization of the employer to permit the PDP as well as integration of the provider of services 121 with the existing payroll processing system of the employer.

To the extent the aforementioned embodiments collect, store or employ personal information provided by individuals, such information shall be used in accordance with all applicable laws concerning protection of personal information. Additionally, the collection, storage and use of such information may be subject to consent of the user to such activity, for example, through well known “opt-in” or “opt-out” processes as may be appropriate for the type and intended user of the information. Storage and use of information, such as for use in generating and updating a profile, may be performed in a secure manner through various encryption and anonymization techniques accordingly.

The validation module 203 operates in connection with the authentication module 201 to validate the status of a user of the incentive platform 103. The validation may be performed as a security measure or in connection with an established incentive program 119 as a condition for execution. By way of example, the validation module 203 validates whether an employee is active with an employer, the entity or tax status of the employee, the availability of a provider of services 121, etc. The validation procedure may include processing security credentials, password information or other input provided by a user. In addition, the validation module 203 may access an enterprise resource 107 associated with the employer and/or employee. In this case, the ability of the validation module 203 to access the enterprise resource 107 per user provided credentials may be cause for validation. Likewise, the presence of information regarding the user that matches expected information for the user (e.g., employer or employee identifier, name information, service provider identifier, social security number, network address) as maintained by the enterprise resource 107 may be a cause for validation.

Still further, the validation module 203 may validate one or more conditions for execution of a program, as established per the programming module 209, are met. This may be based on the analysis of contextual information gathered by various sensors 102 of the user device 101. The contextual information may include location information, biometric data regarding the employee, temporal information, network signal information, or the like. By way of example, location information (e.g., geospatial coordinates) for an employee may be gathered by the sensors 102 and subsequently processed by the validation module 203 for analysis. The location may then be validated by the module 203 to determine if it matches known location and/or proximity conditions established by the employer. As another example, a device identifier for the user device 101 may be validated to determine if it matches a recognized device identifier of the employer. Meeting of the above described contextual conditions may enable execution of various aspects of an incentive program 119, i.e., the enrollment procedure, the ability to make purchases, adjustments to participation levels, etc.

The participation module 205 determines a participation level associated with an employee or group thereof. In addition, the participation module 205 enables the establishment of a participation level by an employer or designated primary within a group. The designated primary may include, for example, an employee that founded or initiated a group, the group leader, etc. By way of example, the participation module 205 may receive a direct input from an employer or designated primary for indicating the participation level to associate with a given employee. Alternatively, the participation module 205 may assign a participation level to an employee based on programmatic factors such as performance, merit, seniority or other criteria. For example, the participation module 205 may assign a certain number of points, a rank, a tier or classification to employees based on their seniority level. As another example, the participation module 205 may assign the level based on the departmental affiliation of the employee, a performance evaluation result, etc.

Still further, the participation module 205 may assign a participation level to an employee based on their rate of use or participation in an incentive program. For example, the participation module 205 may interact with a transaction management module 207 to determine a frequency of use of the incentive platform 103 by an employee to purchase services 121 of a provider. As another example, the participation module 205 may assign the participation level based on the value or quantity of purchases made, the purchase type, group affiliation, location/region, etc. It is noted that the assigned participation level may be processed by the validation module 203 for validating the eligibility of the employee to participate in an incentive program 119. Furthermore, the participation level may determine the frequency or amount of purchases capable of being made, the amount of contribution to be made by the employer with respect to an established payroll deduction of the employee towards a purchase, or a combination thereof.

The transaction module 207 enables purchases to be made by way of a payroll deduction based on a defined incentive program 119. By way of example, the transaction module 207 may operate in connection with the authentication module 201 to enable the establishment of a payroll deduction program, including the defining of an amount of deduction and a coordinated frequency thereof. The transaction module 205 may determine the amount and frequency based on the selection of one or more items and/or benefits by the employee for purchase, a specified number of purchases to occur per period, etc. Under this scenario, the transaction module 207 receives and processes this as input provided by the employee per the user interface module 215. For example, the employee may be presented with one or more selection options (e.g., buttons or checkboxes) for indicating an item and/or benefit of interest.

The transaction module 207 associates the above described purchase settings with the profile maintained for the employee. In addition, the transaction module 207 operates in connection with the reporting module 211 to track and monitor initial and subsequent transactions performed by the employee in response to execution of and/or participation in a defined incentive program 119. In this way, the transaction module 207 may record transactional details—purchases, winnings, participation level changes, etc.—throughout the lifecycle of participation of the employee in the employer sponsored incentive program 119.

The programming module 209 facilitates the design and implementation of an incentive program 119. By way of example, the programming module 209 may operate in connection with the user interface module 215 to render various data entry fields, buttons, menus or the like for enabling the employer to select configure an incentive program. As such, the programming module 209 receives user input for establishing various parameters, rules and/or criteria (e.g., program information) for defining the incentive program or scheme. This may include, for example, specification of the employees or groups thereof that are eligible to enroll in the program, establishment of participation levels (as relayed to the participation module 205), specific services 121 to be made available and the like.

In addition, the programming module 209 may enable the establishment of various conditions. The conditions may be set to establish one or more custom scenarios and may be executed by the incentive platform 103 as design constraints and/or programmatic triggers of the incentive program 119. For example, the employer may stipulate criteria for executing a purchase match in the case where a 10% growth in work productivity of the employees is achieved. Once established, the programming module 209 ensures execution of the condition during execution of the incentive program 119.

The reporting module 211 generates reports, alerts and documentation associated with transactions performed by the programming module 209 per the employer sponsored incentive program 119. This includes, for example, reports regarding the initial purchase, the delivery and procurement of the services 121, winnings associated with a purchase of services 121 involving a lottery, a sweepstakes or a raffle, etc. In addition, the reporting module 211 may generate financial reports associated with the purchase of items and/or benefits per an employer sponsored incentive program 119. The reports may be presented to the user interface of the application 105 by way of the user interface module 215. Alternatively, the reports may be generated and transmitted as messages via email, short messaging service (SMS) or the like by way of the communication interface 213.

The communication interface 213 enables formation of a session over a network 109 between the incentive platform 103 and the applications 105, systems of various providers of services 121, or a combination thereof. By way of example, the communication module 213 executes protocols and data sharing techniques for enabling collaborative execution between a user device 101 (e.g., mobile devices, laptops, smartphones, tablet computers, desktop computers) and the incentive platform 103 over the network 109. The communication module 213 may also support a browser session—i.e., the retrieval of content as referenced by a resource identifier during a specific period of time or usage of the browser. The browser session may support execution of a purchases, group participation, and other functions associated with an incentive program 119.

The user interface module 215 generates an interface in association with the incentive program 119 in response to application programming interfaces (APIs) or other function calls being made by the application 105. As noted, this may correspond to a browser application or web portal application of the user devices 101. Alternatively, the application may be a dedicated executable (download) of the incentive platform 103, i.e., as downloaded to the user device 101 during execution of the authentication module 201. In either case, the user interface module 215 enables the display of graphics primitives, graphic elements and content of various type to be rendered accordingly.

The above presented modules and components of the incentive platform 103 can be implemented in hardware, firmware, software, or a combination thereof. Though depicted as a separate entity in FIG. 1, it is contemplated that the incentive platform 103 may be implemented for direct operation by respective user devices 101. As such, the incentive platform 103 may generate direct signal inputs by way of the operating system for interacting with the application 105 and executing an incentive program 119. In another embodiment, one or more of the modules 201-215 may be implemented for operation by the user devices, as a platform 103, or a combination thereof. Regardless of the implementation, modules 201-215 as described herein may be used selectively or in combination within the context of an employee sponsored incentive program or scheme.

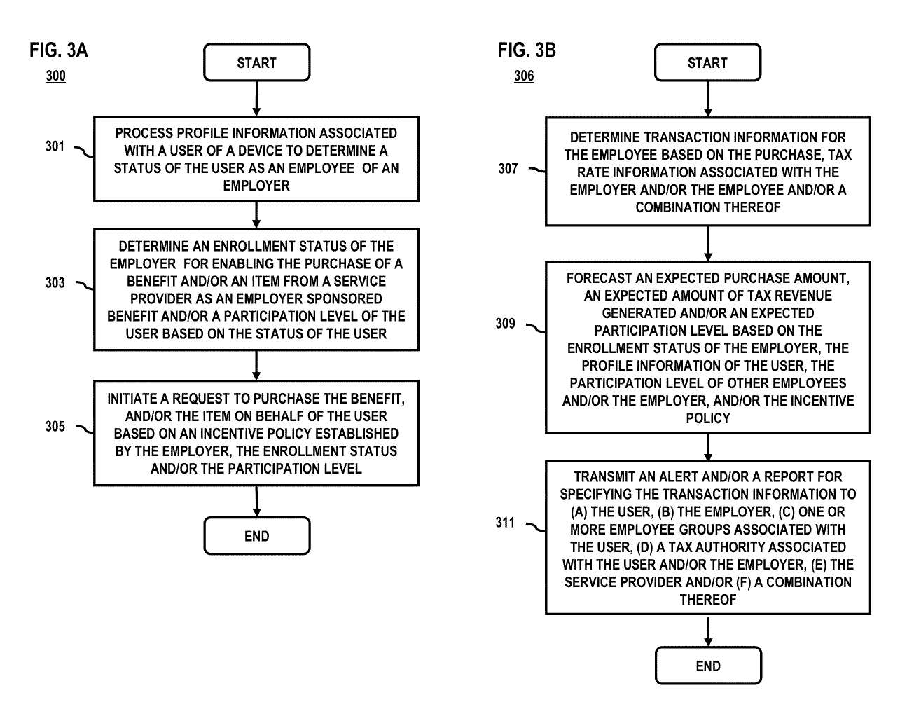

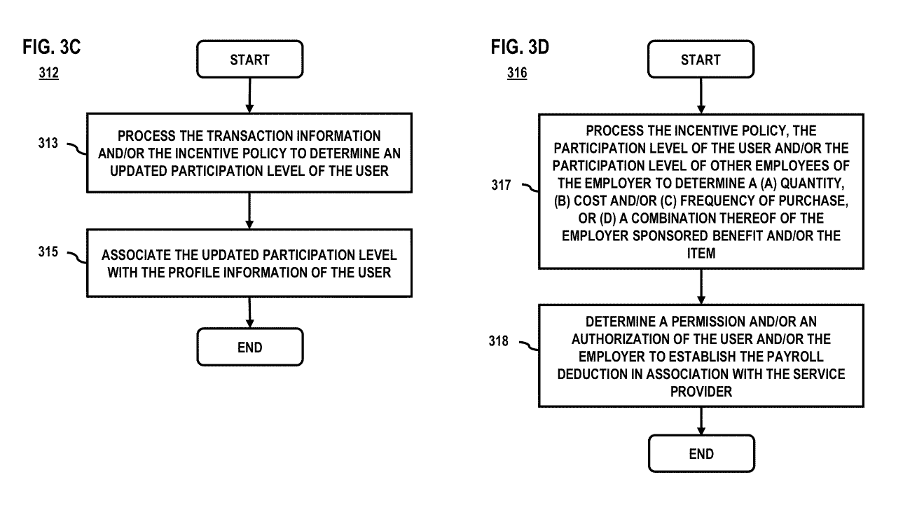

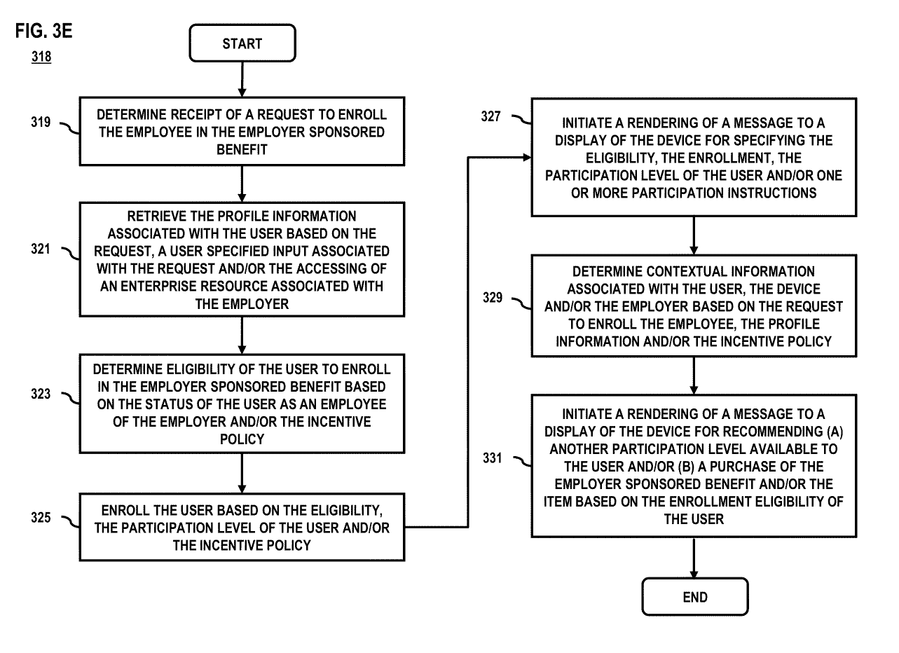

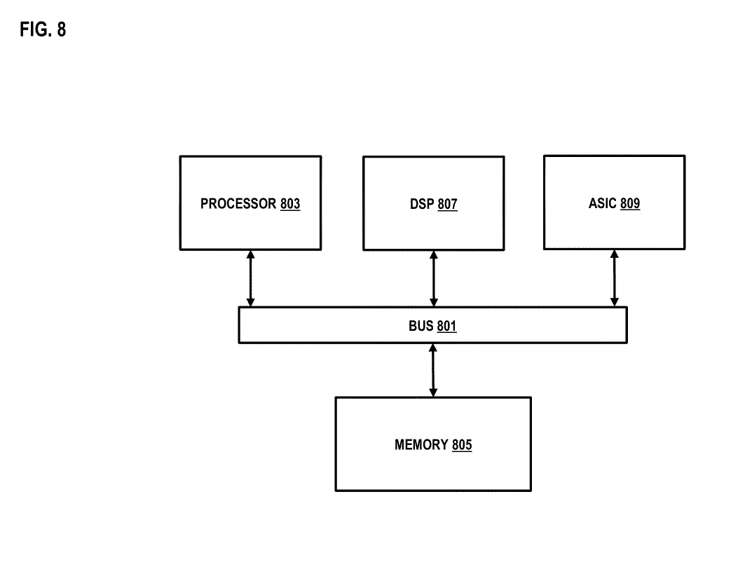

FIGS. 3A-3E are flowcharts of processes for facilitating and monitoring transactions associated with the purchase of employer sponsored benefits and/or incentives, according to various embodiments. The exemplary processes are presented herein for the purpose of illustration only, to further embellish key aspects of the system of FIG. 1. Hence, by way of example, the incentive platform 103 performs processes 300, 306, 312, 316 and 318 in, for instance, a chip set including a processor and a memory as shown in FIG. 8. It is noted that the functional steps of said exemplary processes may be performed in a different order of execution.

In step 301, the incentive platform 103 processes and/or facilitates a processing of profile information associated with a user of a device to determine a status of the user as an employee of an employer. As noted previously, the profile information for the user may include employee contact and address information, employment status and title information, network address and internet protocol information assigned to the user per the employer, email address information, department or group affiliation information or the like. Still further, the profile may specify an assigned participation level, such as a merit level, a bonus level or an employee ranking, for validating the eligibility of the employee to participate in an incentive program 119.

In another step 303, the incentive platform 103 determines an enrollment status of the employer for enabling the purchase of a benefit, an item, or a combination thereof from a service provider as an employer sponsored benefit, a participation level of the user, or a combination thereof based on the status of the user. As noted previously, the purchase may be facilitated by way of a payroll deduction schema established between the employer, the employee and the provider of the benefit or item of interest.

Per step 305, the incentive platform 103 initiates a request to purchase the benefit, the item, or a combination thereof on behalf of the user based on an incentive policy established by the employer, the enrollment status, the participation level, or a combination thereof. As noted previously, the enrollment status may specify whether or not the employer is registered with the incentive platform 103. This would include, for example, validating the establishment of an employer profile at a profile database 117 for specifying details regarding the employer, i.e., employer contact and address information, the number of employees associated with the employer, a tax or corporate entity status of the employer, an employer identifier or corporate tax identifier, network address and internet protocol information for the employer, email address information, primary contact persons or key administrators of the employer and the like.

In step 307 of process 306 (FIG. 3B), the incentive platform 103 determines transaction information for the employee based on the purchase, tax rate information associated with the employer, the employee, or a combination thereof, or a combination thereof. As mentioned previously, the transaction information specifies the purchase record, the purchase amount, fulfillment information associated with the purchase, an amount of winnings associated with the purchase, an amount of taxes due based on the winnings, the tax rate information, or a combination thereof, tax reporting information associated with the purchase, the winnings, or a combination thereof, or a combination thereof.

In step 309, the incentive platform 103 forecasts an expected purchase amount, an expected amount of tax revenue generated, an expected participation level, or a combination thereof based on the enrollment status of the employer, the profile information of the user, the participation level of other employees, of the employer, or a combination thereof, the incentive policy, or a combination thereof. Per step 311, the incentive platform 103 transmits an alert, a report, or a combination thereof for specifying the transaction information to (a) the user, (b) the employer, (c) one or more employee groups associated with the user, (d) a tax authority associated with the user, the employer, or a combination thereof, (e) the service provider, or (f) a combination thereof. It is noted that the alert, the report, or a combination thereof is based on the forecast.

In step 313 of process 312 (FIG. 3C), the incentive platform 103 processes and/or facilitates a processing of the transaction information, the incentive policy, or a combination thereof to determine an updated participation level of the user. The updated participation level may correspond to an increased participation level assignment based on the interaction of the user with the third party service provider per the employer sponsored incentive program (as defined per the incentive policy). In another step 315, the incentive platform 103 associates the updated participation level with the profile information of the user. This may include, for example, storing the updated participation level to the profile of the user for subsequent reference.

As mentioned previously, the incentive policy specifies one or more rules, conditions, criteria or a combination thereof for (a) initiating a transaction between the employer, the employee, the service provider, or a combination thereof for enabling the purchase of the benefit, the item, or a combination thereof, (b) assigning a participation level to the user, (c) indicating an enrollment status of the employer, or (d) a combination thereof. Hence, the incentive policy may be executed as one or more programmatic instructions, i.e., as an incentive program, designed for enabling the purchase of the employer sponsored benefit. Of note, the one or more rules, conditions and/or criteria of the incentive policy may include the purchasing of benefits and/or items via payroll deduction.

In step 317 of process 316 (FIG. 3D), the incentive platform 103 processes and/or facilitates a processing of the incentive policy, the participation level of the user, the participation level of other employees of the employer, or a combination thereof to determine a (a) quantity, (b) cost, (c) frequency of purchase, or (d) a combination thereof of the employer sponsored benefit, the item, or a combination thereof. It is noted that the incentive policy, the purchase of the employer sponsored benefit and/or the item, or a combination thereof is based on a payroll deduction.

In another step 319, the incentive platform 103 determines a permission, an authorization, or a combination thereof of the user, the employer, or a combination thereof. Under this scenario, the payroll deduction may be required to be established by the employee with the provider of the service and authorized for integration with a payroll service of the employer (or third party provider thereof) accordingly. As such, the payroll deduction is executed based on the quantity, the cost, the frequency of purchase, or a combination thereof as established for the user.

In step 319 of process 318 (FIG. 3E), the incentive platform 103 determines receipt of a request to enroll the employee in the employer sponsored benefit. The request may correspond to a registration request, an opt-in agreement to enable purchase transactions via payroll deduction, user preferences, etc. In another step 321, the incentive platform 103 retrieves profile information associated with the user based on the request, a user specified input associated with the request, the accessing of an enterprise resource 107 associated with the employer, or a combination thereof. The user input may include manually entered user credentials or registration data. Also, the profile information may specify said one or more employee credentials and the enrollment request, the accessing of the enterprise resource, or a combination thereof is initiated by the user, the employer, or a combination thereof.

In steps 323 and 325 respectively, the incentive platform 103 determines eligibility of the user to enroll in the employer sponsored benefit based on the status of the user as an employee of the employer, the incentive policy, or a combination thereof and enrolls the user based on the eligibility, the participation level of the user, or a combination thereof. Per step 327, the incentive platform 103 initiates a rendering of a message to a display of the device for specifying the eligibility, the enrollment, the participation level of the user, one or more other participation levels, one or more participation instructions, or a combination thereof. As noted previously, the one or more participation levels are designated by the employer, one or more user groups associated with the employer, one or more departmental groups associated with the employer, or a combination thereof as one or more employee types, one or more employment tenure categories, one or more points, one or more tiers, one or more performance levels, a ranking, or a combination thereof.

In step 329, the incentive platform 103 determines contextual information associated with the user, the device, the employer, or a combination thereof. As noted previously, the eligibility of the employee, the participation level of the user, or a combination thereof may be based on the contextual information and the contextual information may include network address information, geographic location information, biometric information, device identifier information, or a combination thereof. This may correspond to a security or authentication execution of the incentive platform 103, a conditional execution, or a combination thereof.

In another step 331, the incentive platform 103 initiates a rendering of a message to a display of the device for recommending (a) another participation level available to the user, (b) the purchase of the employer sponsored benefit, the item, or a combination thereof, or (c) a combination thereof based on the enrollment eligibility of the user. It is noted that the recommendation may be presented for the purpose of motivating an employee to further participate in the employer sponsored incentive program 119 for the purchase of benefits and/or items via payroll deduction.

Any reference herein to the ‘user’ in the aforementioned processes 300, 306, 312, 316 and 318 may correspond to the employee, the employer or the provider of services 121. As such, the incentive program 101 may serve as an independent facilitator and monitor of transactions between the different parties based on a defined incentive program 119.

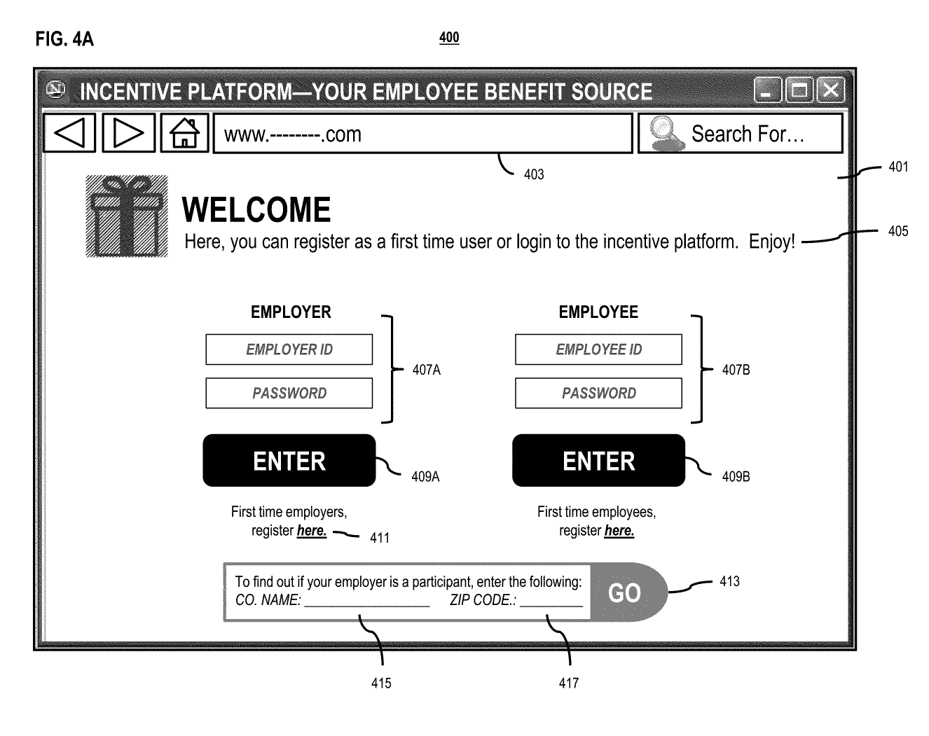

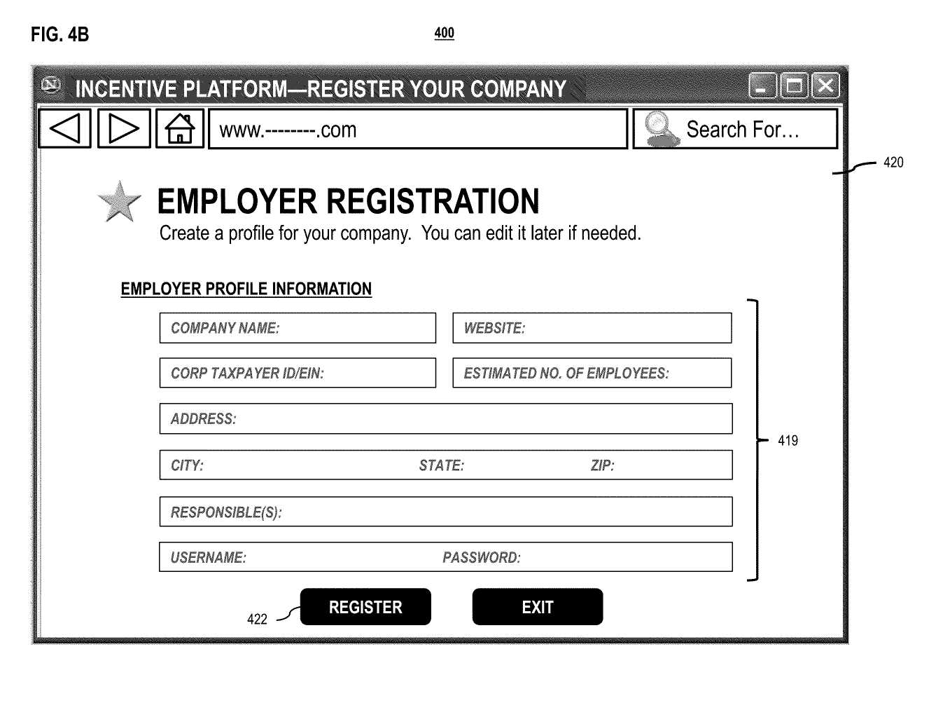

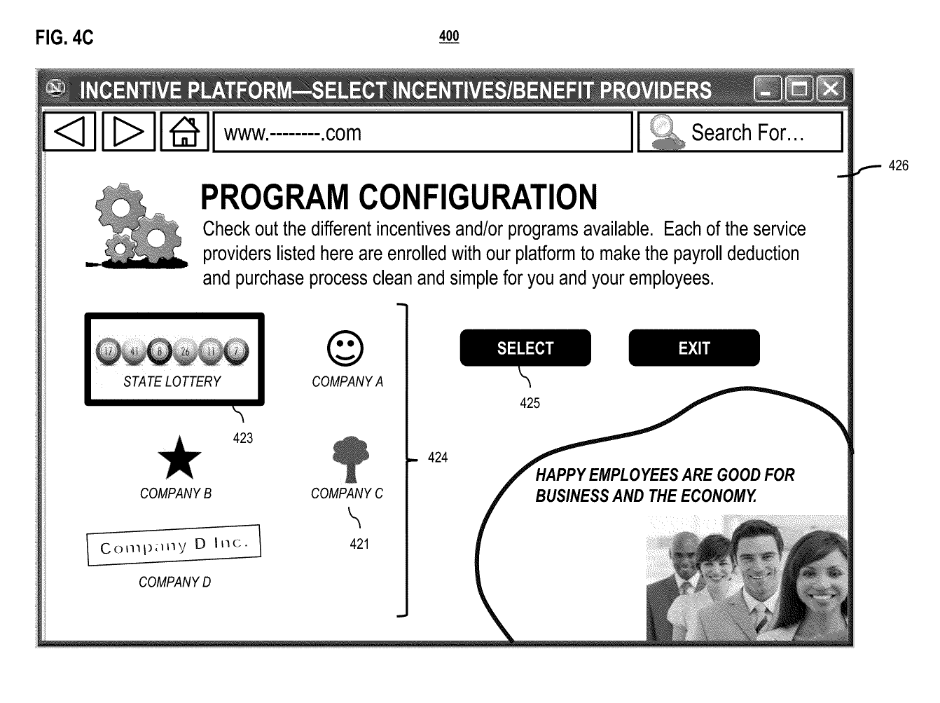

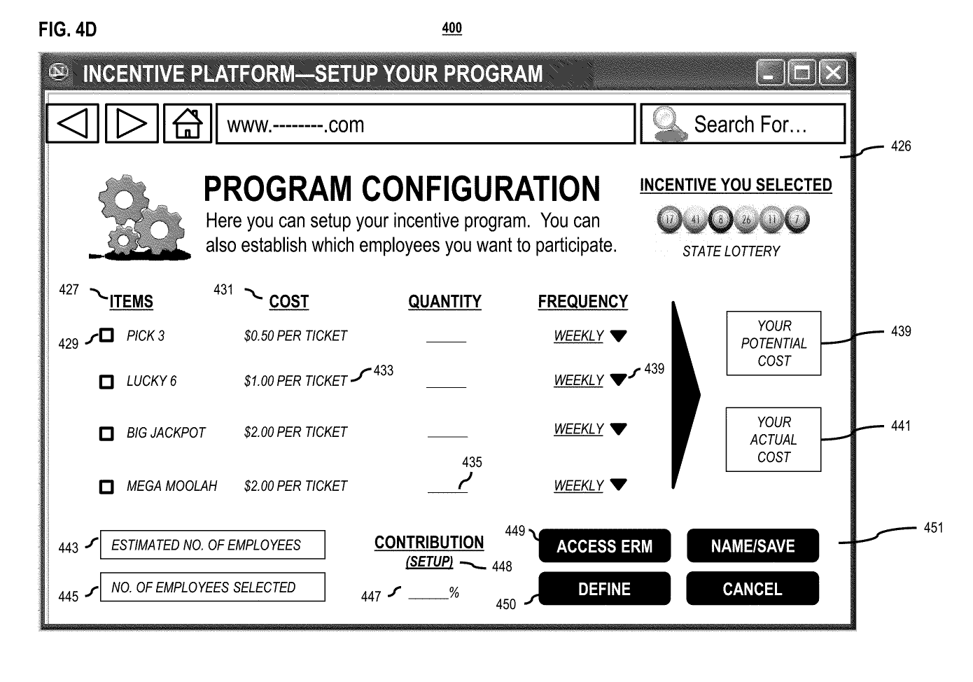

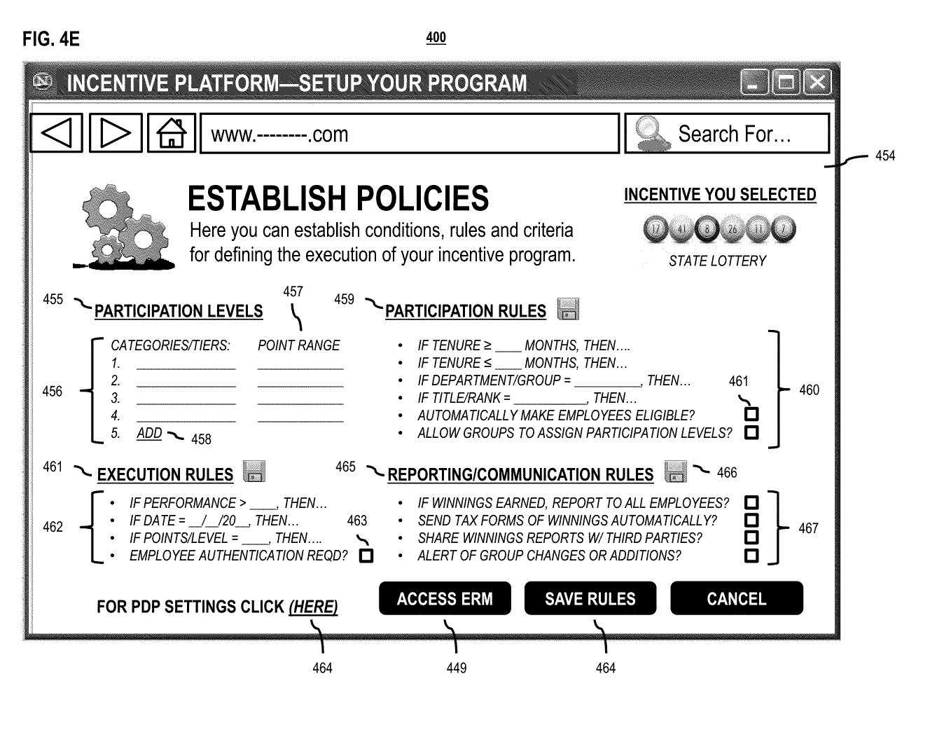

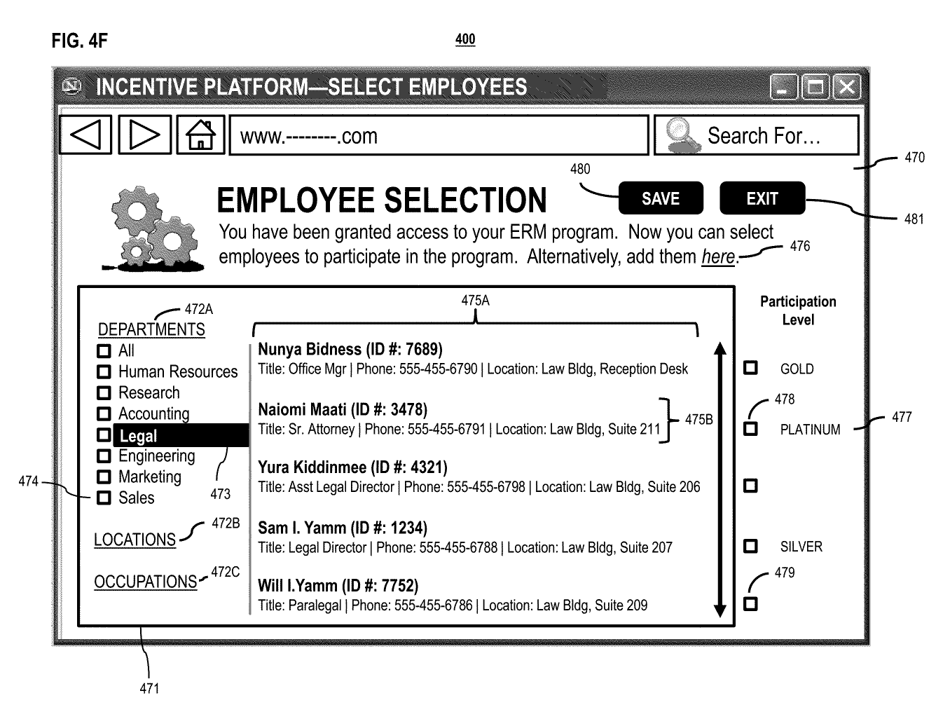

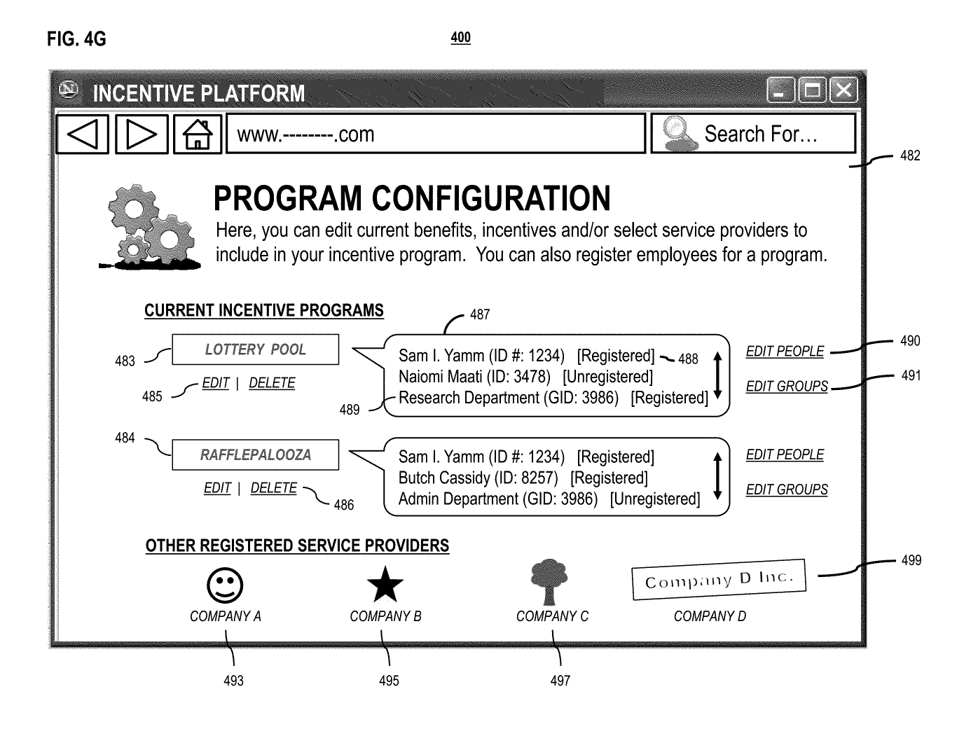

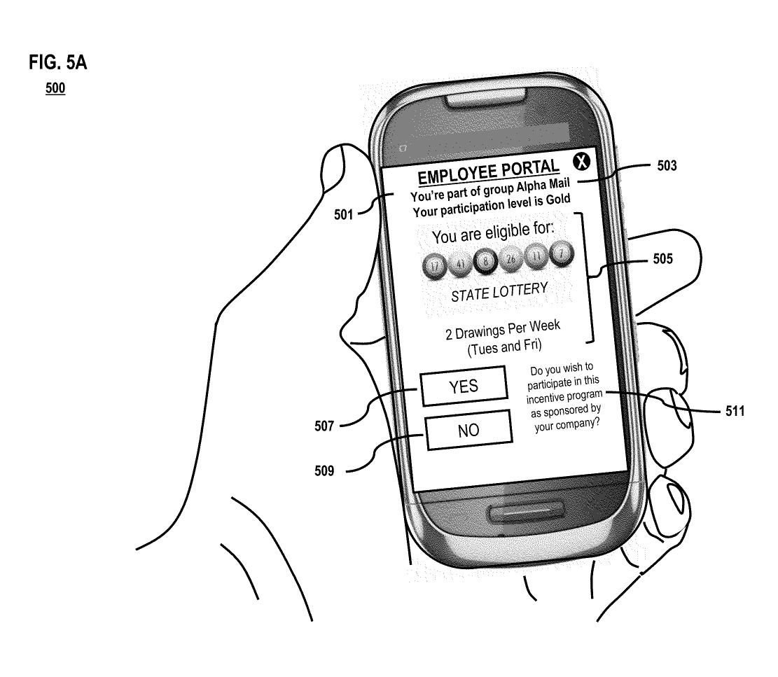

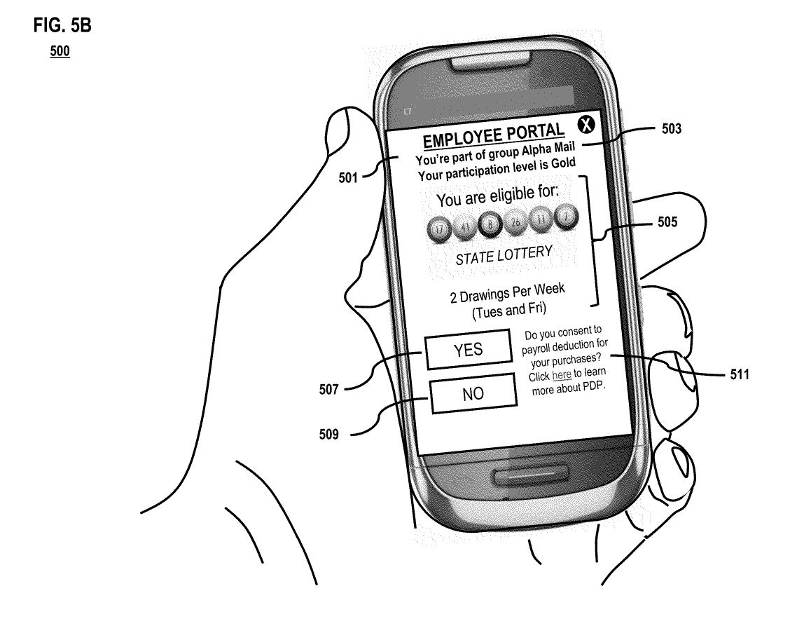

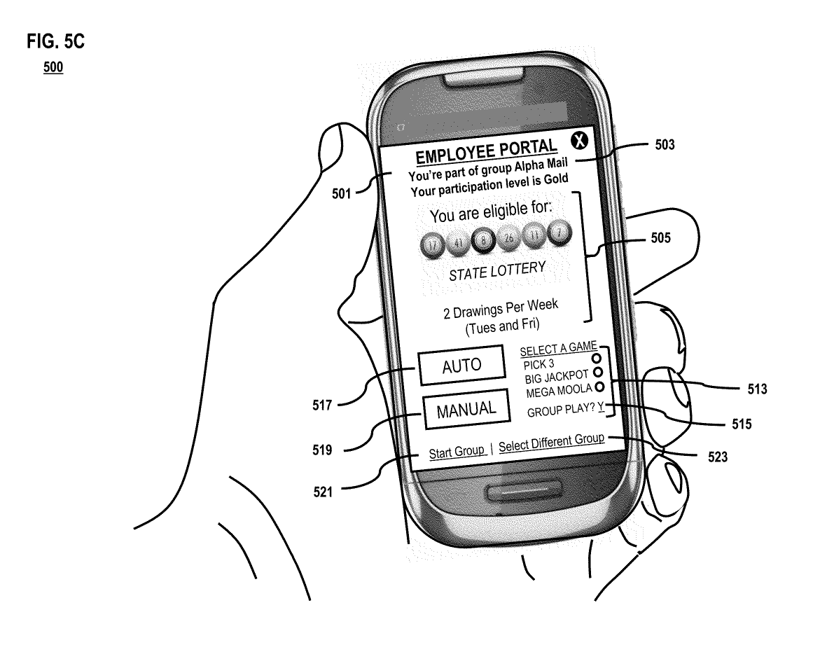

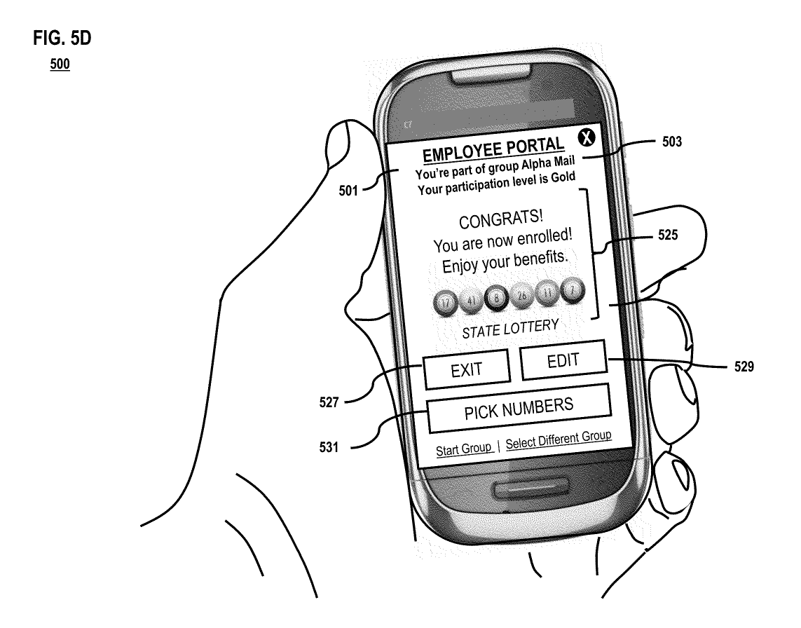

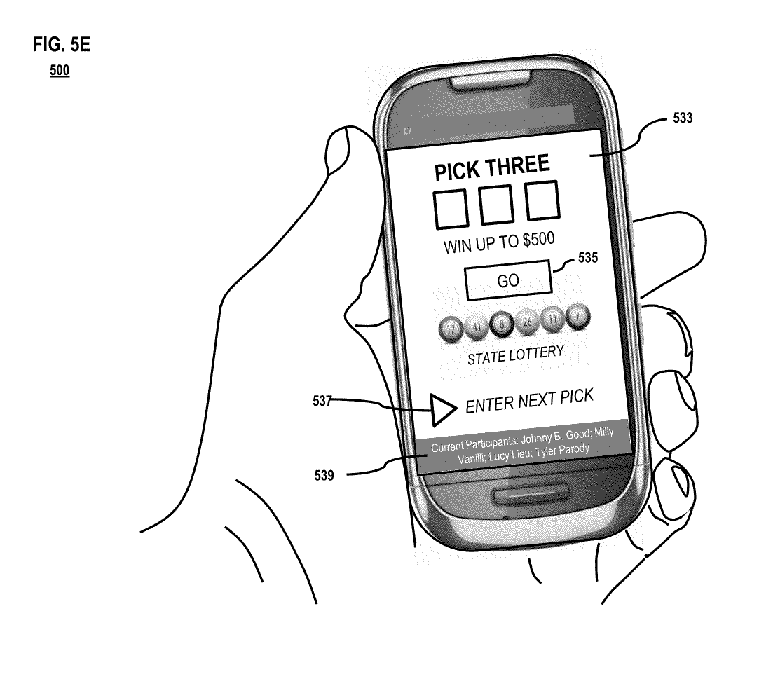

FIGS. 4A-4G and 5A-5E are diagrams of user interfaces for facilitating and monitoring transactions associated with the purchase of employer sponsored benefits and/or incentives, according to various embodiments. For the purpose of illustration, the diagrams are described with respect to an exemplary use case of an employer and employee interacting with the incentive platform 103. It is noted that while the user interface depictions correspond to the process of facilitating and monitoring transactions associated with the purchase of employer sponsored benefits and/or incentives, the devices may be configured to cause presentment of various additional screens based on communication between the devices and the platform 103.

In FIG. 4A, a user of a device (e.g., laptop computer, mobile phone) accesses a user interface of the incentive platform 103 via a browser application 400. The user may access the interface 401 by entering a uniform resource locator (URL) corresponding to the network location of the incentive platform 103 into an address field 403 of the user interface 401. Alternatively, the user may access the interface 401 by way of a secure sign-on procedure executed from an intranet site of an employer.

By way of example, the user is presented with a welcome message 405 along with one or more selection options for interacting with the incentive platform 103. In the case where the user is an employer (e.g., a representative thereof), the user enters their employer identifier and password into login fields 407A. In the case where the user is an employee, the user enters their employee identifier and password into login fields 407B. Once entered, the user may select an ENTER action button 409A (for a user representing the employer) or 409B (for a user representing an employee) for initiating a login process with the incentive platform 103. It is noted that this execution corresponds to a scenario wherein the login credentials were previously established due to registration of the user. In the case where no prior registration has occurred, the user may initiate the registration by selecting a registration link (i.e., link 411).

In the case where the user is an employee, the employee may also be presented with one or more employer enrollment verification fields 415 and 417. As such, the user may provide input via these fields 415 and 417 in order to verify the employer (e.g., company) they work for is actually registered with the incentive platform 103. In addition, the employee may verify that an incentive program 119 has been defined by the employer. Under this scenario, the employee may enter the name of the company/employer in a company name field 415 and the corresponding zip code of the employer in the zip code field 417. The employee then selects the GO action button 413 to transmit the data and initiate the verification process.

The verification procedure may include cross-referencing the company name and zip code as entered in fields 415 and 417 respectively against existing employer profile information. Under this scenario, the search may be performed according to any known data mining or information search techniques. When a match occurs, the employee is presented with a message for indicating the employer is officially registered. In addition, the message may include a list of the different incentive programs being sponsored by the employer along with the service providers for which the programs are designed around. From there, the employee may then proceed to establish various settings (e.g., items of interest, groups to participate in, purchase frequency) for transacting with the incentive platform 103.

When no match is found as a result of a verification request, the employee is presented with an instruction or option to request that the employer register with the incentive platform 103. This may include, for example, initiating the sending of an email to the employer on behalf of the employee for expressing interest in the development of an incentive program for employees. As another example, the incentive platform 103 may generate an entry in a contact management system or calendar system for scheduling a phone call to be placed to the employer from a representative associated with a provider of services 121. Still further, the incentive platform 103 may transmit a text message to a representative of the employer for enticing them to design and offer an incentive program for the employees.

In the case where the employer must register with the incentive platform 103, the employer selects the registration link 411. This results in a registration interface 420 being rendered to a display of the employer's device, as depicted by way of example in FIG. 4B. The registration interface 420 may include various data entry fields 419 for establishing an employer profile. In this example, this includes fields for specifying the name of the employer (e.g., company name), a website address, an employer identifier/tax identifier number, an estimated number of employees of the employer and address information including the state in which the employer is located or headquartered. In addition, the names of a responsible person or representative of the employer may also be specified, along with an input for specifying a preferred username and password of the employer. Once entered, the employer may select a REGISTER action button 422 to signify completion of the data entry process and store the entered employer profile data to the profile database 117 of the incentive platform 103. This corresponds to completion of the registration procedure and enables the employer to begin designing/configuring an incentive program.

It is contemplated, in certain embodiments, that the incentive platform 103 may perform a validation of the employer as a precursor to enabling the registration or in conjunction with the registration. The validation may include, for example, validating the status of the employer, the address, corporate registration, etc. Under this scenario, the incentive platform 103 may cross reference the employer identifier, the company name and other profile information entered against a corporate registration database, a business directory, a tax/public record source or other resource for validating the status and existence of the employer. Also, the incentive platform 103 may cross reference the address against postal authority records for validating the address. Still further, the IP address associated with the website information as entered may be cross referenced against known internet registration records to determine if the registration matches that of the employer. It is noted that the verification procedure may be performed for security and authentication purposes, such as to prevent the generation of an invalid or fake employer registration. The incentive platform 103 may be configured to prevent the registration or require additional information or actions on the part of the registrant in the case where the validation procedure fails.

In FIG. 4C, the employer accesses a configuration interface 426. The configuration interface 426 presents various selection options for enabling the registered employer to design an incentive program based on one or more available services. The services featured include only those of providers that are also registered with the incentive platform 103—i.e., have an established service provider profile. In this case, the employer is presented with graphic images (e.g., icons) 424 for representing the different providers of services available for selection. Hence, the employer is able to view the icons in the form of a corporate logo, a slogan or other brand identifier, for determining a provider in which to build an incentive program around.

After reviewing the options, the employer may select the provider of interest by way of a mouse click or touchscreen input. In this example, when the employer selects the state lottery as their provider of choice, the state lottery icon is highlighted by way of a highlight box 423. Once selected, the employer then activates the SELECT action button 425 to indicate to the incentive platform their selection and initiate additional configuration options. It is noted that while multiple different icons 424 and thus providers may be available, the incentive platform 103 may enforce selection of only one provider at a time. Under this scenario, a first incentive program associated with the state lottery provider must be established before a second incentive program associated with a provider named Company C (corresponding to icon 421) is established.

In FIG. 4D, the employer is presented with additional options for implementing an incentive program per the configuration interface 426. The options enable the employer to establish which services are to be offered as part of the defined incentive program along with the employees that are to be eligible for participation. Still further, the configuration interface 426 may present the employer with data for determining a potential or actual cost of the employer for offering the incentive program.

Under this scenario, the employer is presented with a list of items 427 to be offered as part of the incentive program. The list of items 427 specify the different lottery ticket offerings available for purchase from the state lottery provider. In this case, the four different ticket types are listed, each of which may be selected via a checkbox (e.g., checkbox 429). In addition, cost information 431 for each ticket is presented along with data entry fields (e.g., quantity field 435) for enabling the employer to specify the number of tickets to be purchased. Still further, the employer may be presented with a drop down menu (e.g., 439) for selecting a frequency of purchase of the selected items 427. The drop down menu (e.g., 439) may include various frequency selections options, including a daily, weekly, bi-weekly, monthly or semi-monthly frequency. In addition, a ‘custom’ selection option may be presented for enabling the employer to specify one or more custom days of purchase. It is noted that a default frequency option, i.e., weekly, may be initially specified per the configuration interface 426.

The configuration interface 426 also presents various options for coordinating the participation of employees in the incentive platform 103. For example, fields 443 and 445 may be presented for indicating the estimated number of employees or an actual number of employees (as selected) for participation in the incentive program 119. The estimated number of employees may be populated automatically with a numeric value provided by the employer per the registration interface 420. Alternatively, the employer may manually enter the estimated number of employees directly into the field 443. In addition, the employer may specify an amount of money they will contribute towards the purchase of any of the items 427 selected for inclusion in the incentive program 119. In this case, the employer contribution 447 may be expressed as a percentage, a matching amount, a dollar amount, etc. Alternatively, the employer may click a setup link 448 to further customize the employer contribution 447, including enabling the defining of the contribution as an offset rather than as a match to the cost of the items 427, specifying a quantity match or multiplier, indicating a pool of available funds to be associated with the program, etc.

In this example, the configuration interface 426 also features an indicator 439 for indicating the potential cost to the employer for sponsoring the program. The potential cost is therefore determined based on different variables established by the employer, including the estimated number of employees 443, the amount of money to be contributed by the employer 447 for the purchase of items 447, cost information 431 for each item 427, the quantity of items to be purchased and the frequency in which the items are purchased. It is noted that the potential cost indicator 439 will present a value based on the frequency of purchase selected by the employer. For instance, in the case where the frequency is established as weekly, the final value for the potential cost will be presented as a weekly total as well. Alternatively, the employer may select the potential cost indicator 439 to adapt the period of calculation to daily, monthly, quarterly, yearly or the like.

Unlike data entry field 443, the number of employees selected field 445 is not able to be manually modified by the employer. Rather, the number of employees selected field 445 presents a numeric value for indicating the actual number of employees that have already been configured for participation with the incentive program 119 by the employer. This includes, for example, those employees for whom an employee profile has already been generated and for whom a participation level has been assigned accordingly. As such, the number of employees selected field 445 presents a running total of the number of employees assigned to participate in the incentive platform 103.

The employer may select employees to include in the incentive program by selecting an ACCESS ERM action button 449. In this case, the ACCESS ERM action button 449 causes an employee selection interface 470 to be rendered to the browser application 400, as depicted in FIG. 4F. This results in an access procedure being performed with an enterprise resource management (ERM) tool, such as a human resources management system, of the employer. Under this scenario, the employer may be prompted to input access credentials or provide other data for access validation purposes (not shown). Once access is granted, a content frame 471 may be presented within the employee selection interface 470 for displaying an interface to the enterprise resource management tool. Per this execution, the content frame 471 may be executed by way of an object viewer or web service associated with the ERM.

The ERM interface as displayed to the content frame 471 may include a filter list for enabling the employer to search through an employee directory by category. The filters may include, for example, a department filter 472A, a location filter 472B or an occupation list 472C for enabling a lookup based on department affiliation, work location/building or occupation type respectively. In the case where the employer selects the department filter 472A, a drop down list is further presented for specifying different departmental options. The employer may select a particular department to view, such as by way of touchscreen input or mouse selection (e.g., mouse click). For example, when the employer selects the legal department, the selection 473 is highlighted and a list 475A of all employees belonging to the legal department is shown. Alternatively, the employer may activate a checkbox (e.g., checkbox 474) for selecting multiple departments at a time to be rendered to the list 475A.

The list 475A may include different entries corresponding to each employee. Each entry may include profile information regarding the employee, including for example, the assigned employee identifier, the employee's title, the phone number of the employee and their building code and/or location. Also presented alongside each entry is a checkbox (e.g., checkbox 478) and a designated participation level associated with the employee featured in the entry. The participation levels in this example correspond to different tiers as defined by the employer per one or more participation settings. In this example, some of the employees are assigned participation levels (e.g., Platinum) based on points accumulated, group participation, tenure, etc., while others have no participation level designation at all. The employer may select an employee as being eligible for participation in the incentive program regardless of whether a participation level is assigned,

The employer has the option to select the checkbox (e.g., checkbox 478) in order to designate the employee as eligible for participation in the incentive program. For example, in the case where the employer wishes to select an employee named Naiomi Maati (ID #: 3478) for inclusion in the program, the employer activates the checkbox 478 corresponding to entry 475B for this employee. Alternatively, the employer may render an employee named Will I. Yamm as ineligible by deselecting the checkbox 479 corresponding to the entry for this employee. The employer may scroll through the list 475A as needed to select and/or deselect employees. Once all selections are made, the employer then selects the SAVE action button 480 in order to activate the selections. This may correspond to an updating of the profiles of the respective employees selected to indicate their enrollment/eligibility. The employer may then select the EXIT action button 481 in order to logout of the enterprise resource management system and return to the program configuration interface 426 (or other interface of the incentive program 103).

In addition to accessing an ERM, the employer may also manually specify one or more employees to participate in the incentive program by selecting a DEFINE action button 450 of the program configuration interface 426 of FIG. 4D. Selection of this action button causes the incentive platform 103 to render a registration interface to the browser 400 for enabling the generation of an employee profile. While not shown expressly herein, the registration interface may be similar to that of registration interface 420 as presented in FIG. 4B. Under this scenario, the interface may feature various data entry fields for enabling the employer to provide input regarding the employee. This may include, for example, the employee name and contact information, the employee's title and departmental affiliation, an employee identifier, etc. In addition, the employer may specify the eligibility and participation level of the employee.

It is noted, therefore, that the incentive platform 103 may accommodate different means of acquiring and/or generating the profile information required to specify employees for participation in a defined employer sponsored incentive program. This includes enabling means of accessing of the data from a network accessible resource as well as manual input means. In the case of the latter, a profile generated via the incentive platform 103 may optionally be exchanged with an enterprise resource of the employer at a later time.

In addition to specifying employees, the DEFINE action button 450 may also enable the employer to access a policy configuration interface 454. The policy configuration interface 454 enables the employer to establish conditions, rules and/or criteria for defining execution of the incentive program. For example, the employer may be presented with fields 456 for defining the participation levels 455 to be utilized amongst employees (e.g., companywide), including data entry fields for labeling the different categories/tiers of participation levels in order of priority. Under this scenario, the employer may define a first and highest participation level as “Black Belt,” a second highest priority level as “Brown Belt,” a third highest priority level as “Yellow Belt” and a lowest priority participation level as “White Belt.” The employer may also select an ADD link 458 in the case where additional levels and priorities are required. In addition, the employer may optionally define a point range corresponding to each level, wherein the accumulation of points enables the ascension of an employee to higher participation levels. It is noted that defining of point ranges 457 may enable further programmatic executions to be performed, including triggering the execution of certain transactions (e.g., the ability to purchase certain items) for an employee based on the number of points accumulated or the participation level achieved, associating the number of points with a performance review, etc.

The policy configuration interface 454 may also include participation rules settings 459, for enabling the employer to define various conditions and rules 460 for managing and adapting the participation levels of employees. For example, a first rule may be based on employee tenure, wherein if the tenure is less than or equal to a certain number of months, the participation level of the employee may be increased. Another rule may be based on department or group, wherein employee affiliation with said department or group results in assignment of a certain participation level or an addition of points. In the case of the latter, for example, the appointment of an employee to a companywide recycling task force may result in the allocation of 100 additional points, which may further increase the participation level of said employee. The increase in points serves as a means of the employer to incent the employee for their participation in the task force.

It is noted that certain of the participation rules 460 may be presented as IF-THEN expressions, wherein the condition (IF) and the conditional execution (THEN) are predetermined. Per this approach, the expressions may be presented relative to the particular items 427 or service provider thereof or offered generically by the incentive platform 103. Alternatively, the employer may select one or more actions to be performed conditionally, corresponding to the THEN execution of the expression. In addition, the rules 460 may include one or more YES/NO options, which may be enabled or disabled based on activation of a checkbox (e.g., checkbox 461). For example, a rule for automatically making all employees eligible for participation in a defined incentive program or another for enabling groups to assign participation levels internally may be enabled or disabled at the discretion of the employer. Various other participation rules may be presented.

The policy configuration interface 454 may also present various execution rules settings 461, for enabling the employer to define conditions and rules 462 for affecting the interaction between employees and the incentive platform 103. For example, a first rule may be based on a date condition, wherein fulfillment of the specified date results in activation of a bonus contribution by the employer or other action. In addition, the rules 462 may also include one or more YES/NO options, which may be enabled or disabled based on activation of a checkbox (e.g., checkbox 463). For example, a rule for requiring employee authentication may be activated as a security measure for permitting employee interaction with the incentive platform 103. In addition to the above, the employer may further establish various payroll deduction permissions/settings/preferences by selecting a PDP link 464.

Still further, the policy configuration interface 454 may present various reporting and communications rules settings 465, for enabling the employer to define conditions and rules 467 for managing communication between employees and the incentive platform 103. The rules may include various conditional expressions as well as one or more YES/NO selection options. For example, a first option for reporting winnings to all employees of the employer or to only those within an affiliated group may be selected (e.g., via a checkbox). Another example may be activation of a setting of sharing winnings of all amounts with a third party, such as a tax authority. This option may be executed based on consent of the employee as well. Still further, various selection options (not shown) for adapting the frequency of report generation and transmission, the format, the data types, etc., may be established.

It is noted that the above described participation rules settings 459, execution rules settings 461 and reporting and communication rules settings 465 may also be established by way of a script file or other executable. For example, the employer may import a script file for indicating the preferred reporting and communication settings from a data store of the employer. The importation action may be initiated by selecting a document retrieval button 466, which is presented in this case as an icon representative of a disk. Per this approach, the script to be retrieved and executed will conform to a format and data syntax suitable for processing by the incentive platform 103. As a result, the employer can forgo manually establishing the rules settings.

While not depicted herein, it is noted that the rules and/or conditions as presented for configuration may be executed globally for all employees or alternatively on an employee-by-employee basis. In the case of the latter, for example, more restrictive rules settings 459, 461 and 465 may be applied to the Chief Executive Officer than to other employees as a means of regulating the assignment of participation levels, managing the perception of equity amongst participants in the incentive program 109, etc. This may include restricting the eligibility of certain employees and thus restricting the execution of rules and/or conditions for said employees. In certain instances, the employer may delineate between different factions and/or types of employees by accessing an enterprise resource management (ERM) tool, as described in FIG. 4F.

Once the rules and/or conditions are set, the employer then selects the SAVE RULES action button 464. As a result, the policies to be executed as, or in association with, the incentive program 119 may be stored in reference to the employer profile. Furthermore, the policy configuration interface 454 may be closed, such as in the case where it was opened via a separate browser application 400 window. Alternately, the content corresponding to the prior interface execution, which in this case corresponds to the program configuration interface 426 (FIG. 4D), is loaded into the browser accordingly. It is noted that the policy configuration interface 454 may be accessed from various other interfaces of the incentive platform 103, such as by way of an action button, a link, a site map, etc.

Having defined the policies and established one or more employees to participate in the incentive program 119 (e.g., per FIG. 4E), various other executions may be performed. For example, the number of employees selected 445 field is updated to depict the number of employees selected for participation in the incentive program. As such, the estimated number of employees field 443 may differ from the number of employees selected field 445. Similarly, an actual cost indicator 441 may be updated to present an actual cost of implementation of the incentive program 119. The actual cost indicator 441 reflects the cost to the employer for a defined time period (e.g., daily, weekly, yearly) as a result of the selection of employees and the implementation of specific policies. Hence, the actual cost indicator 441 may differ from the potential cost indicator 439 as it accurately accounts for the policy nuances and employee participants.

It is noted that the above described potential cost and actual cost indicators 439 and 441 respectively may be dynamically updated based on the adaptation of variables for affecting their value. For example, in the case where the employer adapts their contribution amount as specified per field 447 or deselects a particular item 427 for inclusion in the program, the potential cost indicator 439 will be updated to reflect this change. As another example, when the employer increases the number of estimated employees 443 while maintaining all other variables the same, this results in the potential cost indicator 439 increasing accordingly. Still further, the actual cost indicator 441 is dynamically adjusted in the case where the employer adapts the employee selection or one or more of the rules and/or conditions defined as policy (depending on the rule and/or condition).

Hence, the program configuration interface 426 enables the employer to evaluate different incentive programming scenarios. In addition, the program configuration interface 426 allows the employer to readily compare the actual cost of implementation of the incentive program against the potential cost. As such, the employer may generate various scenarios to meet budget constraints, participation objectives, etc., prior to naming and saving the incentive program 119. While not shown expressly herein, additional content may also be presented to the employer during the configuration process for facilitating programming of the incentive. This may include, for example, the presentment of different metrics and statistics for indicating historical or estimated employee response levels, feedback information of case studies of other employers and employees that have instituted an incentive program, potential tax savings options for the employer per the state of domicile (where applicable) based on execution of an incentive program, group rate pricing options made available by the various providers of services 121, etc.

Once the configuration process is deemed complete, the employer may then select the NAME/SAVE action button 451. Activation of this action button signifies the readiness of the employer to formally offer the newly defined and/or updated incentive program to the eligible employees. As a result, the incentive platform 103 first prompts the employer to select a name to be associated with their incentive program, i.e., a file name of the programmatic instructions for storage to the program database 119. Under this scenario, the employer may retain a program name designated by the provider of the services 121 (e.g., in the case where the employer selected a predetermined program). Alternatively, the employer may create a custom name (e.g., “Awesome Employee”) or select a name suggested by the incentive platform 103. The incentive program is then stored accordingly in connection with the employer profile. It is contemplated, in certain implementations, that the incentive program established by one employer may optionally be stored in connection with a different employer profile. This execution may correspond to a shared incentive program, and thus shared cost agreement, between different employers.

Pursuant to saving of the incentive program, a payroll processing system or provider of the employer may be notified of the incentive program. The notification may specify details regarding the authorization of the employer to enable the establishment of a payroll deduction program (PDP) for eligible employees in connection with their participation in the incentive program 119, PDP setup requirements, etc. In addition, an email or text message may automatically be generated and sent to the eligible employees or companywide for indicating the availability and/or existence of the incentive program 119. The email or text message may include instructions for participation, access rules, details regarding the services 121 available for purchase, etc. In certain implementations, the email or text may also specify an access credentials to be used by the employee for enabling them to enroll in the incentive program 119. The access credentials may include, for example, a code, a login identifier, a verification link as embedded within the message content, or the like. Hence, initial enrollment of an eligible employee for participation in incentive program 119 per the incentive platform 103 may require the use of the access credentials provided by the employer.

FIG. 4G depicts the program configuration interface 482 in the case where the employer already has a defined incentive program 119. In this case, the employer is already registered with the incentive platform 103 and may need to edit the existing policies associated with the incentive program, add or delete participants eligible for participation, etc. As such, the program configuration interface 482 may present various selection options for adapting the incentive program accordingly.

In this example, the configuration interface 482 features icons 483 and 484 for specifying the programs currently being offered by the employer. Icons 483 and 484 correspond to programs entitled (named) by the employer as “Lottery Pool” and “Rafflepalooza” respectively. The interface also features an edit link 485 for enabling the editing of the rules and/or conditions as well as a delete link 486 for deleting the existing incentive program. In the case of the former, selection of the edit link 485 causes rendering of the policy configuration interface in a manner similar to the policy configuration interface 454 of FIG. 4E. From this interface 482, the employer may be presented with the current (prior established) participation rules 459, execution rules 461, participation levels 455, etc. The employer may then proceed to adapt the settings as required and save the established rules per the SAVE RULES action button 464.

The configuration interface 482 also presents a quick view listing (e.g., 479) of the current employees that are eligible for participation in the incentive program. For example, per the quick view listing 487 associated with the Lottery Pool program (as represented by icon 483), the list entries specify the names of the employees, their employment identifier and their registration and/or enrollment status with the incentive program. In addition, the entries may specify the names of eligible departments of the employer or established employee groups, a group identifier 489 and the registration and/or enrollment stats of the department or group. The registration/enrollment status (e.g., 488) is presented to indicate which of the eligible employees are actively participating in the incentive program. Per this view, the employer may therefore determine which employees have responded to the announced incentive program. While not shown herein, the employer may also be presented with a counter for indicating the number of days the employee has been unenrolled as well as an option to send a reminder message to the eligible employees to participate.

Still further, the configuration interface 482 may also present additional information regarding the employee as an expanded detail view (not shown). The expanded detail view may be presented in response to a touchscreen input or mouse selection of a particular entry of interest, i.e., the entry for the employee named Naiomi Maati. Per the expanded detail view, additional profile information regarding the employee such as their title, phone number and location may be presented within the quick view list 487. In addition, the incentive platform 103 may be integrated with a phone system of the employer for initiating a phone call. Alternatively, the incentive platform 103 may be integrated with a chat platform of the employer for initiating the sending of an instant message.

The configuration interface 482 may also present an edit person link 490 for enabling the employer to add additional employees to the eligibility list or remove existing employees from the list of eligible participants. Under this scenario, selection of the edit people link 490 causes a rendering of a participation list, which may include one or more checkboxes for enabling the employer to select or deselect an employee. Alternatively, the employee selection interface 470 may be presented for enabling the employer to access their ERM tool and adapt their employee selections accordingly.

The employer may also select an edit group link 491 in order to add or remove existing groups participating in the incentive program. For example, the employer may decide to add a group entitled “Community Service” to the existing list of groups participating in the incentive program as a way of rewarding a select group of employees that are part of a community service initiative. In addition to defining the group, the employer may also specify the employees that are to be part of the group, i.e., by accessing and selecting employees via the ERM tool as per the employee selection interface 470. It is noted, therefore, that groups may be broadly defined to include entire departments or a limited group of employees. Furthermore, groups may be established by the employer or by employees themselves (e.g., based on participation rules 459 enabled by the employer).

The configuration interface 482 may also present the employer with options to establish another incentive program. Under this scenario, the interface features icons 493-499 for representing different providers of services. By selecting an icon, the incentive platform 103 causes the rendering of the program configuration interface 426 of FIG. 4D. In this way, the employer may establish which of the available services are to be offered, the frequency and quantity of purchase, determine potential or actual cost data, etc.

It is noted that the interface features, options and content may varying depending on the type of service being selected. For example, in the case where the employer selects icon 497 corresponding to the provider of a service for planting trees as a community service initiative, the items list 427 and frequency of purchase options presented per the configuration interface 426 may vary from that shown in FIG. 4D. Rather than weekly purchases being made, for example, a weekly or monthly installment may be made towards the overall cost of planting a tree in the name of an employee or group thereof. As another example, another item in the list may include a contribution/donation to a forestry and wildlife preservation agency.

Still further, the rules and/or conditions presented to the employer may vary from that shown in FIG. 4E based on the selected provider 497. For example, instead of enabling the reporting of winnings as per a lottery service provider context, a reporting/communication rule setting 465 of the policy configuration interface 454 of FIG. 4E may include an option to report the number of trees actually planted. Also, rather than sending tax forms regarding winnings automatically, an option may be selected to automatically send a report/notice from the service provider for validating the charitable donation. Under this scenario, the report/notice may indicate the name of the charitable organization, the date and amount of contribution, a letter of thanks from the service provider and any other document required by a tax authority for recording purposes (i.e., as required by the Pension Protection Act of the Internal Revenue Service).

In FIG. 5A, a user of a mobile device 500 decides to enroll with the incentive platform 103 in order to participate in an incentive program. In this example, the user is an employee deemed eligible by their employer to participate in the incentive program 119; the employee having received a message regarding their eligibility along with enrollment credentials and instructions. For the purpose of illustration herein, the employee accesses the incentive platform 103 via a browser application that is capable of presenting network based content and facilitating data processing tasks via a display 501. It is noted, however, that the user may also download a dedicated application to the mobile device 500 for executing the functions of the incentive platform 103. Under this scenario, the download may be performed by clicking on a download link as provided in the message regarding eligibility, by visiting a mobile/device application store, by visiting a download section of a website associated with the incentive program or a provider of a service, etc.

Under this scenario, when the employee enters the uniform resource locator of the incentive platform 103 to their browser application, an employee portal interface 501 is rendered to the display of the device 500. The employee is then able to login to the incentive platform 103 using the enrollment/login credentials provided by the employer. Hence, it is noted that the employee need not generate a profile as it was already generated in its entirety or at least in part by the employer. Once logged in, the employee portal interface 501 presents various content for indicating the current status and enrollment options available to the employee.

Under this scenario, a group participation message 503 is presented for indicating the employee is currently part of the ‘Alpha Mail’ group. For the purpose of illustration, this is a group founded by another employee or the employer for the benefit of employees that work in a mail room. The participation message 503 also indicates the current participation level of the employee. It is noted, in the case where the employee is a member of other groups, that these other groups would also be specified per the group participation message 503 accordingly.

Also presented to the employer portal interface 501 is an eligibility message 505 for specifying the particular service provider and/or items available for purchase as an employer sponsored benefit. In this case, the eligibility message 505 indicates the employee is eligible to participate in an incentive program involving the purchase of items from a state lottery provider. The message further indicates the employee is eligible to participate in two drawings per week on specific days of the week (e.g., Tuesday and Friday). Of note, the frequency of purchases may be initially established by the employer per the policy configuration interface of FIG. 4E. The employee may subsequently adapt the frequency or other settings as long as changes are granted by the employer per the policies.

The employee may also be presented with a message 511 for requesting whether the employee wants to participate in the incentive program for which they are eligible. Under this scenario, the employee may respond to the message 511 by selecting the YES or NO action buttons 507 and 509 respectively. When the employee selects the YES action button 507, this input is transmitted to the incentive platform 103 to indicate the employer wants to complete the enrollment process. Resultantly, an additional message 511 is rendered to the employee portal interface 503 for requesting whether the employee consents to establishing a payroll deduction for enabling the purchase of the specified benefit, per FIG. 5B. The message 511 may also feature a link for presenting the employee with details and options for establishing the payroll deduction with the employer and/or the provider of the lottery service. Consent is granted by the employee when they select the YES action button 507 or denied when the employee selects the NO action button 509.

In FIG. 5C, the employee portal interface 501 renders an option selection message 513 to the display of the mobile device 500. The selection message 513 specifies the items available for purchase via the employer sponsored incentive program. Under this scenario, the employee may activate checkboxes corresponding to the selection of a Pick 3 drawing, a Big Jackpot drawing and a Mega Moola drawing. The employee may also indicate whether they want to participate in the purchase independently or as part of the group they are affiliated with (Alpha Mail) by selecting a toggle switch 515. The toggle switch 515 enables the employee to toggle between a Yes (Y) indicator and a No (N) indicator accordingly.

Once the selections are made, the employer may indicate their purchase preferences by selecting an AUTO action button 517 or MANUAL action button 519. Selection of the AUTO action button 517 indicates the employer wants to enable automated/consistent purchases of the selected items per the established frequency indicated by the employer per the eligibility message 505. Alternatively, the employee may select the MANUAL action button 519 to adapt the purchase frequency or indicate the purchase frequency is to be performed on demand. Per this selection, purchases are made at the discretion of the employee via payroll deduction rather than on an automated/consistent basis.

The employee portal interface 501 also presents links for enabling the employee to adapt or establish group settings. For example, a start group link 521 may be selected for presenting options to the display of the mobile device 500 for founding a group of employees to participate in the incentive program. As another example, a select different group link 523 may be selected for presenting a list of other groups affiliated with the employer. Under this scenario, the list may feature the different employee groups that are also participating in the incentive program. When the employee selects a group, a request message may be transmitted to the group participants for indicating that the employee would like to join. Resultantly, the request to join the group is delayed pending a vote and/or consent of the group.

In FIG. 5D, having established their setting and preferences, the employee portal interface 501 presents a message 525 for indicating the employee has successfully enrolled in the incentive program 119. In response, the employee may choose to exit the interface 501 by selecting the EXIT action button 517. Alternatively, the employee may select the EDIT action button 529 in order to edit their participation settings (e., purchase frequency, item selections). Still further, the employee may select the PICK NUMBERS action button 531 in order to submit numbers to play for a particular drawing with the lottery service provider.

Upon selection of the PICK NUMBERS action button 531, a lottery play interface 533 is rendered to the display of the mobile device 500. The lottery play interface 533 may correspond to an execution of the lottery service provider directly—i.e., accessing of the website of the provider. Under this scenario, the interface 533 enables the employee to enter numbers related to a Pick Three game. Once the entered into the appropriate data input fields, the employee then selects the GO action button 535 to submit the numbers. In addition, the employee may select a next button 537 for proceeding to the next games selected for play (e.g., Mega Moola). It is noted, in the case where group play was selected, the members of the group may be presented to the display as content 539 for reference by the employee. Additional play options and user interface executions may be presented accordingly depending on the type of item and/or benefit being offered, the policies of the incentive program, etc.

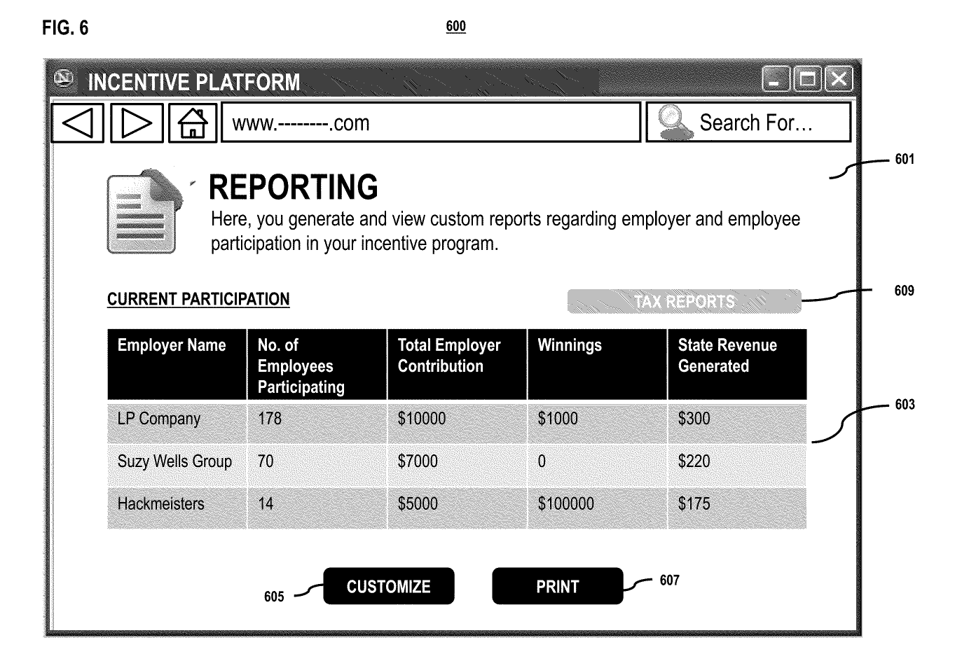

In FIG. 6, a reporting interface 601 may be rendered to a browser application 600 by the incentive platform 103 for presenting data (e.g., metrics, charts, reports, images, text) regarding the transactions executed by employees and/or employers with respect to a provider of services. The reporting interface 601 may be accessed by the employer, the employees or the service provider for generating and viewing custom reports regarding an employer sponsored incentive program. A CUSTOMIZE action button 605 may be selected to enable customization of the report. Upon selection, various options may be presented to the user interface for affecting the presentment of data, including one or more data filters, data table settings, formatting and reporting options, etc. Also, a PRINT action button 607 may enable the printing or publishing of the report.

In this case, the service provider (lottery service provider) accesses the reporting interface 601 to view a table 603 for indicating various columns of information. The columns may be specified for inclusion in the report, based on the customization options selected, to include data for indicating the names of employers having an incentive program established with the provider, the number of employees associated with the employers, the amount of services purchased, the amount of winnings to date, an amount of state revenue generated (tax revenue), etc. While not shown herein, the reporting interface 601 may further enable other reporting options to be executed, including the establishing of a report generation frequency, the selection of report recipients, the execution of various analytic algorithms against certain data sets, etc.

It is noted, in the case where the provider of the service is a lottery service provider, that purchases and winnings earned may be actively associated with the respective employees that made the purchases per the incentive platform 103. This may include, for example, associating the employee identifier, the tax payer identification of the employer or the like with each transaction record entry for enabling persistent monitoring and linking of transactions with specific taxpayers. As such, the reporting interface 601 may also include a TAX REPORTS action button 609 for enabling generation of tax documentation regarding winnings earned as a result of a purchase transaction. Upon selection of this button 609, the service provider may be presented with a list of the specific employees that earned winnings, the exact amount of the winnings and the tax revenue due as a result of said winnings. The service provider my further be presented with an option to generate a message or applicable earnings reporting forms to be sent to the employee as a result of these earnings. Depending on the preferences of the service provider, this report may be sent automatically to the employer or employee.

Likewise, in the case where the reporting interface 601 is being accessed by an employee or employer, the TAX REPORTS action button 609 may result in the presentment of a tax form, report or other documentation required for accounting for winnings. It is noted that this execution may be performed regardless of the amount of the winnings. Similarly, a message may be presented for indicating that the employer and/or service provider has enabled the disclosure of information regarding winnings to the appropriate tax authorities.

It is noted that the above described functions and processes of the incentive platform 103 may be executed or implemented in connection with one or more existing systems of the employer or service provider. As such, the incentive platform 103 may be functionally or systemically integrated with said existing systems for performing some or all of the above described purchasing, monitoring and reporting functions of the incentive platform 103. This may include, for example, integrated operation of the incentive platform 103 with: an enterprise resource 107 of an employer, one or more web servers of the provider, one or more web services or data processors, or the like.

Also, the processes described herein for facilitating and monitoring transactions associated with the purchase of employer sponsored benefits and/or incentives may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

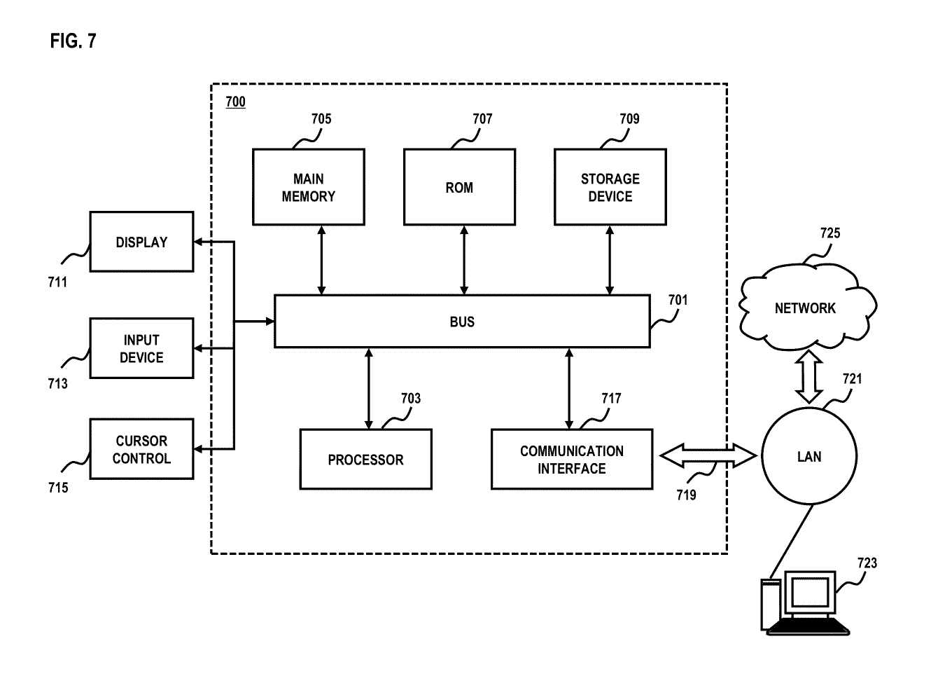

FIG. 7 is a diagram of a computer system that can be used to implement various exemplary embodiments. The computer system 700 includes a bus 701 or other communication mechanism for communicating information and one or more processors (of which one is shown) 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for adjusting cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 8 illustrates a chip set or chip 800 upon which an embodiment of the invention may be implemented. Chip set 800 is programmed to facilitate and monitor transactions associated with the purchase of employer sponsored benefits and/or incentives as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of facilitating and monitoring transactions associated with the purchase of employer sponsored benefits and/or incentives.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to facilitate and monitor transactions associated with the purchase of employer sponsored benefits and/or incentives. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
processing and/or facilitating a processing of profile information associated with a user of a device to determine a status of the user as an employee of an employer;
determining an enrollment status of the employer for enabling the purchase of a benefit, an item, or a combination thereof from a service provider as an employer sponsored benefit, a participation level of the user, or a combination thereof based on the status of the user; and
initiating a request to purchase the benefit, the item, or a combination thereof on behalf of the user based on an incentive policy established by the employer, the enrollment status, the participation level, or a combination thereof.

2. A method of claim 1, further comprising:
determining transaction information for the employee based on the purchase, tax rate information associated with the employer, the employee, or a combination thereof, or a combination thereof; and
transmitting an alert, a report, or a combination thereof for specifying the transaction information to (a) the user, (b) the employer, (c) one or more employee groups associated with the user, (d) a tax authority associated with the user, the employer, or a combination thereof, (e) the service provider, or (f) a combination thereof,
wherein the transaction information specifies the purchase record, the purchase amount, fulfillment information associated with the purchase, an amount of winnings associated with the purchase, an amount of taxes due based on the winnings, the tax rate information, or a combination thereof, tax reporting information associated with the purchase, the winnings, or a combination thereof, or a combination thereof.

3. A method of claim 2, further comprising:
processing and/or facilitating a processing of the transaction information, the incentive policy, or a combination thereof to determine an updated participation level of the user; and
associating the updated participation level with the profile information of the user,
wherein the incentive policy specifies one or more rules, conditions, criteria or a combination thereof for (a) initiating a transaction between the employer, the employee, the service provider, or a combination thereof for enabling the purchase of the benefit, the item, or a combination thereof, (b) assigning a participation level to the user, (c) indicating an enrollment status of the employer, or (d) a combination thereof.

4. A method of claim 3, further comprising:
forecasting an expected purchase amount, an expected amount of tax revenue generated, an expected participation level, or a combination thereof based on the enrollment status of the employer, the profile information of the user, the participation level of other employees, of the employer, or a combination thereof, the incentive policy, or a combination thereof,
wherein the alert, the report, or a combination thereof is based on the forecast.

5. A method of claim 1, further comprising:
processing and/or facilitating a processing of the incentive policy, the participation level of the user, the participation level of other employees of the employer, or a combination thereof to determine a (a) quantity, (b) cost, (c) frequency of purchase, or (d) a combination thereof of the employer sponsored benefit, the item, or a combination thereof,
wherein the purchase of the employer sponsored benefit, the item, or a combination thereof is based on a payroll deduction, the incentive policy, or a combination thereof.

6. A method of claim 5, further comprising:
determining a permission, an authorization, or a combination thereof of the user, the employer, or a combination thereof to establish the payroll deduction in association with the service provider,
wherein the payroll deduction is executed based on the quantity, the cost, the frequency of purchase, or a combination thereof.

7. A method of claim 1, further comprising:
determining receipt of a request to enroll the employee in the employer sponsored benefit; and
retrieving the profile information associated with the user based on the request, a user specified input associated with the request, the accessing of an enterprise resource associated with the employer, or a combination thereof,
wherein the profile information includes one or more employee credentials and the enrollment request, the accessing of the enterprise resource, or a combination thereof is initiated by the user, the employer, or a combination thereof.

8. A method of claim 7, further comprising:
determining eligibility of the user to enroll in the employer sponsored benefit based on the status of the user as an employee of the employer, the incentive policy, or a combination thereof;
enrolling the user based on the eligibility, the participation level of the user, the incentive policy, or a combination thereof; and
initiating a rendering of a message to a display of the device for specifying the eligibility, the enrollment, the participation level of the user, one or more participation instructions, or a combination thereof,
wherein the one or more participation levels are designated by the employer, one or more user groups associated with the employer, one or more departmental groups associated with the employer, or a combination thereof as one or more employee types, one or more employment tenure categories, one or more points, one or more tiers, one or more performance levels, a ranking, or a combination thereof.

9. A method of claim 8, further comprising:
initiating a rendering of a message to a display of the device for recommending (a) another participation level available to the user, (b) the purchase of the employer sponsored benefit, the item, or a combination thereof, or (c) a combination thereof based on the enrollment eligibility of the user.

10. A method of claim 8, further comprising:
determining contextual information associated with the user, the device, the employer, or a combination thereof based on the request to enroll the employee, the profile information, the incentive policy, or a combination thereof,
wherein the eligibility of the employee, the participation level of the user, or a combination thereof is based on the contextual information and the contextual information includes network address information, geographic location information, biometric information, device identifier information, or a combination thereof.

11. An apparatus comprising:
at least one processor; and
at least one memory including computer program code for one or more programs,
the at least one memory and the computer program code configured to, with the at least one processor, cause the apparatus to perform at least the following:
process and/or facilitate a processing of profile information associated with a user of a device to determine a status of the user as an employee of an employer;
determine an enrollment status of the employer for enabling the purchase of a benefit, an item, or a combination thereof from a service provider as an employer sponsored benefit, a participation level of the user, or a combination thereof based on the status of the user; and
initiate a request to purchase the benefit, the item, or a combination thereof on behalf of the user based on an incentive policy established by the employer, the enrollment status, the participation level, or a combination thereof.

12. An apparatus of claim 11, wherein the apparatus is further caused to:
determine transaction information for the employee based on the purchase, tax rate information associated with the employer, the employee, or a combination thereof, or a combination thereof; and
transmit an alert, a report, or a combination thereof for specifying the transaction information to (a) the user, (b) the employer, (c) one or more employee groups associated with the user, (d) a tax authority associated with the user, the employer, or a combination thereof, (e) the service provider, or (f) a combination thereof,
wherein the transaction information specifies the purchase record, the purchase amount, fulfillment information associated with the purchase, an amount of winnings associated with the purchase, an amount of taxes due based on the winnings, the tax rate information, or a combination thereof, tax reporting information associated with the purchase, the winnings, or a combination thereof, or a combination thereof.

13. An apparatus of claim 12, wherein the apparatus is further caused to:
process and/or facilitate a processing of the transaction information, the incentive policy, or a combination thereof to determine an updated participation level of the user; and
associate the updated participation level with the profile information of the user,
wherein the incentive policy specifies one or more rules, conditions, criteria or a combination thereof for (a) initiating a transaction between the employer, the employee, the service provider, or a combination thereof for enabling the purchase of the benefit, the item, or a combination thereof, (b) assigning a participation level to the user, (c) indicating an enrollment status of the employer, or (d) a combination thereof.

14. An apparatus of claim 13, wherein the apparatus is further caused to:
forecast an expected purchase amount, an expected amount of tax revenue generated, an expected participation level, or a combination thereof based on the enrollment status of the employer, the profile information of the user, the participation level of other employees, of the employer, or a combination thereof, the incentive policy, or a combination thereof,
wherein the alert, the report, or a combination thereof is based on the forecast.

15. An apparatus of claim 11, wherein the apparatus is further caused to:
process and/or facilitate a processing of the incentive policy, the participation level of the user, the participation level of other employees of the employer, or a combination thereof to determine a (a) quantity, (b) cost, (c) frequency of purchase, or (d) a combination thereof of the employer sponsored benefit, the item, or a combination thereof,
wherein the purchase of the employer sponsored benefit, the item, or a combination thereof is based on a payroll deduction, the incentive policy, or a combination thereof.

16. An apparatus of claim 15, wherein the apparatus is further caused to:
determine a permission, an authorization, or a combination thereof of the user, the employer, or a combination thereof to establish the payroll deduction in association with the service provider,
wherein the payroll deduction is executed based on the quantity, the cost, the frequency of purchase, or a combination thereof.

17. An apparatus of claim 11, wherein the apparatus is further caused to:
determine receipt of a request to enroll the employee in the employer sponsored benefit; and
retrieve the profile information associated with the user based on the request, a user specified input associated with the request, the accessing of an enterprise resource associated with the employer, or a combination thereof,
wherein the profile information includes one or more employee credentials and the enrollment request, the accessing of the enterprise resource, or a combination thereof is initiated by the user, the employer, or a combination thereof.

18. A computer readable storage medium including one or more sequences of one or more instructions which, when executed by one or more processors, cause an apparatus to at least perform:
a processing of profile information associated with a user of a device to determine a status of the user as an employee of an employer;
a determining of an enrollment status of the employer for enabling the purchase of a benefit, an item, or a combination thereof from a service provider as an employer sponsored benefit, a participation level of the user, or a combination thereof based on the status of the user; and
an initiating of a request to purchase the benefit, the item, or a combination thereof on behalf of the user based on an incentive policy established by the employer, the enrollment status, the participation level, or a combination thereof.

19. A computer readable storage medium of claim 18, wherein the apparatus is further caused to perform:
a determining of transaction information for the employee based on the purchase, tax rate information associated with the employer, the employee, or a combination thereof, or a combination thereof; and
a transmitting of an alert, a report, or a combination thereof for specifying the transaction information to (a) the user, (b) the employer, (c) one or more employee groups associated with the user, (d) a tax authority associated with the user, the employer, or a combination thereof, (e) the service provider, or (f) a combination thereof,
wherein the transaction information specifies the purchase record, the purchase amount, fulfillment information associated with the purchase, an amount of winnings associated with the purchase, an amount of taxes due based on the winnings, the tax rate information, or a combination thereof, tax reporting information associated with the purchase, the winnings, or a combination thereof, or a combination thereof.

20. A computer readable storage medium of claim 18, wherein the apparatus is further caused to perform:
a processing of the transaction information, the incentive policy, or a combination thereof to determine an updated participation level of the user; and
an associating of the updated participation level with the profile information of the user,
wherein the incentive policy specifies one or more rules, conditions, criteria or a combination thereof for (a) initiating a transaction between the employer, the employee, the service provider, or a combination thereof for enabling the purchase of the benefit, the item, or a combination thereof, (b) assigning a participation level to the user, (c) indicating an enrollment status of the employer, or (d) a combination thereof.
